(19) United States
(12) Patent Application Publication
(10) Pub. No.: US 2005/0244152 A1
(43) Pub. Date: Nov. 3, 2005

(54) Anti-shake apparatus

(75) Inventor: Shuzo Seo, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/115,315

(22) Filed: Apr. 27, 2005

(30) Foreign Application Priority Data
Apr. 30, 2004 (JP) P2004-135170

(51) Int. Cl. G03B 17/00

(52) U.S. Cl. 396/55

(57) ABSTRACT

An anti-shake apparatus of a photographing apparatus comprises a movable-unit and a fixed-unit. The movable-unit has an imaging device and a coil having a horizontal area which has first and second horizontal segments and having a vertical area which has first and second vertical segments, and can be moved and rotated on a plane which is perpendicular to an optical axis of a camera lens of the photographing apparatus. The fixed-unit has a hall-element unit having a horizontal hall-element which is used for detecting a position of the movable-unit in a first direction and having a vertical hall-element which is used for detecting a position of the movable-unit in a second direction, and supports the movable-unit in the movable and rotatable situation on the plane. The hall-element unit has one or more elements as the horizontal hall-element and has two or more elements as the vertical hall-element.

### BACKGROUND OF THE INVENTION

1. Field of the Invention

The present invention relates to an anti-shake apparatus for a photographing device (apparatus), and in particular to a position-detecting apparatus for a movable unit that includes the imaging device etc., and that can be moved for correcting the hand-shake effect.

2. Description of the Related Art

An anti-shake apparatus for a photographing apparatus is proposed. The anti-shake apparatus corrects for the hand-shake effect by moving a hand-shake correcting lens or an imaging device on a plane that is perpendicular to the optical axis, corresponding to the amount of hand-shake which occurs during imaging.

Japanese unexamined patent publication (KOKAI) No. 2002-229090 discloses an anti-shake apparatus for a photographing apparatus. The anti-shake apparatus performs a moving operation of a movable unit, which includes a hand-shake correcting lens, by using a permanent magnet and a coil, and a position-detecting operation of the movable unit, by using a hall element and a permanent magnet.

However, the magnet and yoke are enlarged in first and second directions which are perpendicular to the optical axis and meet vertically, because the parts of the magnet and yoke for detecting the position of the movable unit in the first direction extend toward the parts of the magnet and yoke for moving the movable unit in the first direction, and the parts of the magnet and yoke for detecting the position of the movable unit in the second direction extend toward the parts of the magnet and yoke for moving the movable unit in the second direction.

### SUMMARY OF THE INVENTION

Therefore, an object of the present invention is to provide an apparatus in which the size of the anti-shake apparatus is reduced, by reducing the weight of the movable unit.

According to the present invention, an anti-shake apparatus of a photographing apparatus comprises a movable unit and a fixed unit.

The movable unit has an imaging device and a position-detecting coil having a horizontal position-detecting area which has first and second horizontal position-detecting segments and having a vertical position-detecting area which has first and second vertical position-detecting segments, and can be moved and rotated on a plane which is perpendicular to an optical axis of a camera lens of the photographing apparatus.

The fixed unit has a magnetic-field change-detecting unit having a horizontal magnetic-field change-detecting element which is used for detecting a position of the movable unit in a first direction and having a vertical magnetic-field change-detecting element which is used for detecting a position of the movable unit in a second direction, and supports the movable unit in the movable and rotatable situation on the plane.

The first direction is perpendicular to the optical axis.

The second direction is perpendicular to the optical axis and the first direction.

The first and second horizontal position-detecting segments and the first and second vertical position-detecting segments are parts of the position-detecting coil.

The first and second horizontal position-detecting segments are parallel to the second direction and face the horizontal magnetic-field change-detecting element.

A direction of the current through the first horizontal position-detecting segment is opposite to a direction of the current through the second horizontal position-detecting segment.

The first and second vertical position-detecting segments are parallel to the first direction and face the vertical magnetic-field change-detecting element.

A direction of the current through the first vertical position-detecting segment is opposite to a direction of the current through the second vertical position-detecting segment.

The magnetic-field change-detecting unit has one or more elements as one of the horizontal magnetic-field change-detecting element and the vertical magnetic-field change-detecting element, and has two or more elements as another of the horizontal magnetic-field change-detecting element and the vertical magnetic-field change-detecting element.

### BRIEF DESCRIPTION OF THE DRAWINGS

The objects and advantages of the present invention will be better understood from the following description, with reference to the accompanying drawings in which:

FIG. 1 is a perspective view of a photographing apparatus of the embodiments viewed from the back side of the photographing apparatus;

FIG. 2 is a front view of the photographing apparatus;

FIG. 3 is a circuit construction diagram of the photographing apparatus, in the first and second embodiments;

FIG. 4 is a figure showing the construction of the anti-shake unit, in the first and second embodiments;

FIG. 5 is a view along line A-A of FIG. 4;

FIG. 6 is a figure showing the construction of the first position-detecting coil and the first and second horizontal hall elements and the vertical hall element, in the first embodiment;

FIG. 7 is a view along line B-B of FIG. 6;

FIG. 8 is an example where the location of the point P is calculated on the basis of a location-information of a point A, a point B, and a point C on the movable unit, in the first embodiment;

FIG. 9 is a figure showing the construction of the first position-detecting coil and the first and second horizontal hall elements and the vertical hall element, in the second embodiment;

FIG. 10 is a circuit construction diagram of the photographing apparatus, in the third embodiment;

FIG. 11 is a figure showing the construction of the second position-detecting coil and the first and second horizontal hall elements and the first and second vertical hall elements, in the third embodiment; and

FIG. 12 is an example where the location of the point P is calculated on the basis of a location-information of a point A, a point B, a point C, and a point D on the movable unit, in the third embodiment.

### DESCRIPTION OF THE PREFERRED EMBODIMENTS

The present invention is described below with reference to the embodiments shown in the drawings. In these embodiments, the photographing apparatus 1 is a digital camera. The photographing apparatus 1 has an optical axis LX.

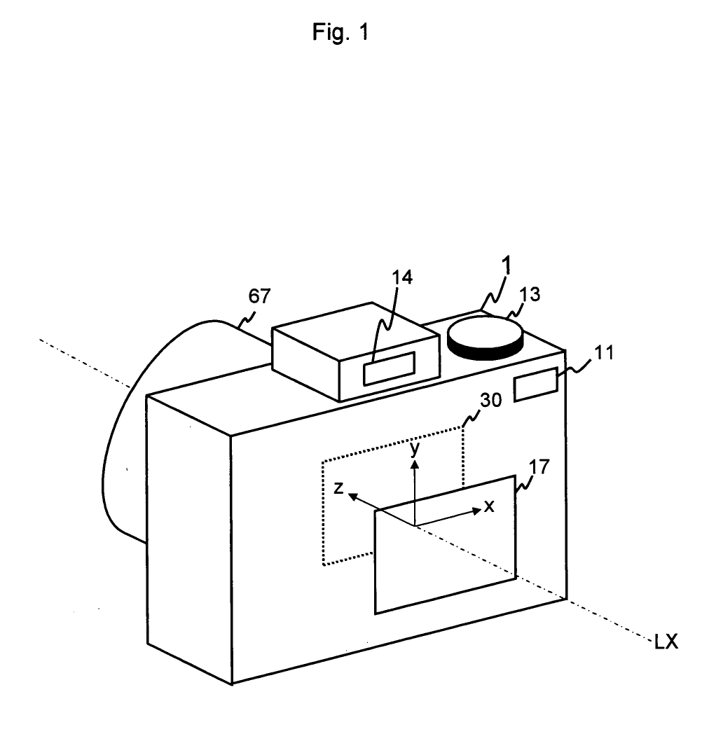

In order to explain the direction in this embodiment, a first direction x, a second direction y, and a third direction z are defined (see FIG. 1). The first direction x is a horizontal direction which is perpendicular to the optical axis LX. The second direction y is a vertical direction which is perpendicular to the optical axis LX and the first direction x. The third direction z is a horizontal direction which is parallel to the optical axis LX and perpendicular to both the first direction x and the second direction y.

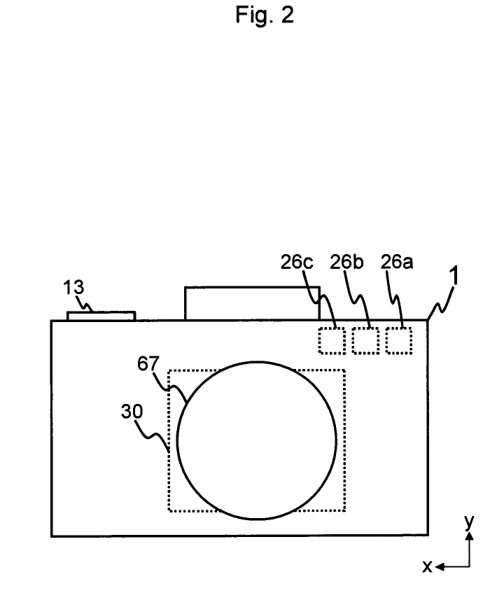

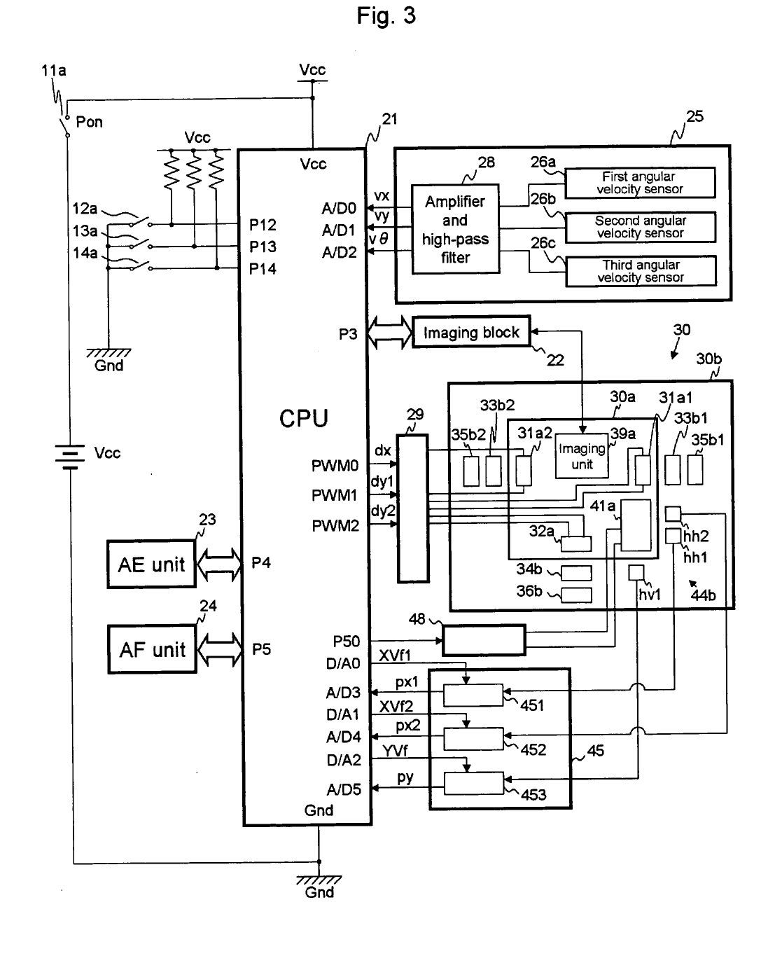

A first embodiment is explained by using FIGS. 1 to 9.

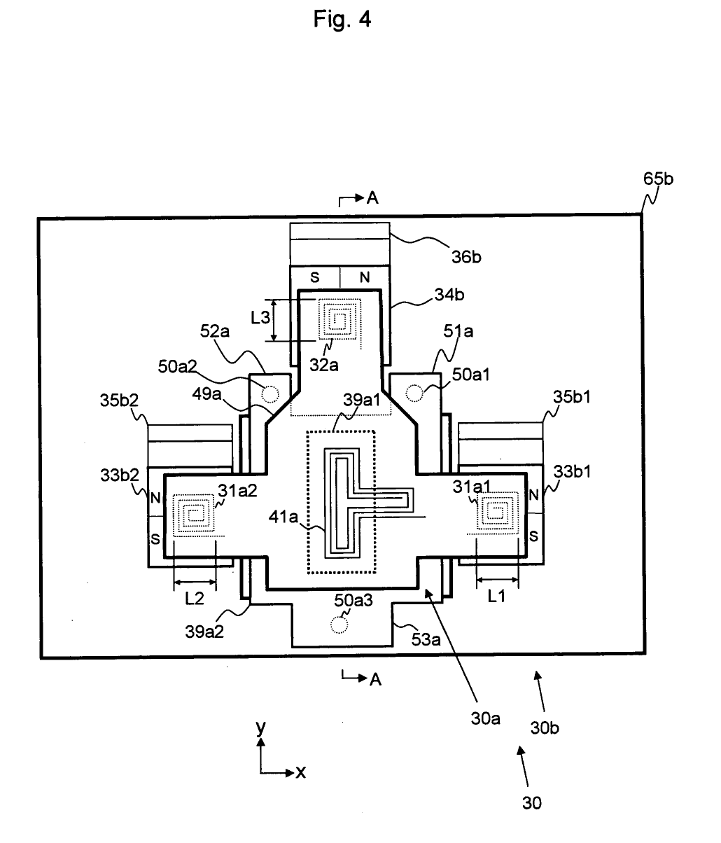

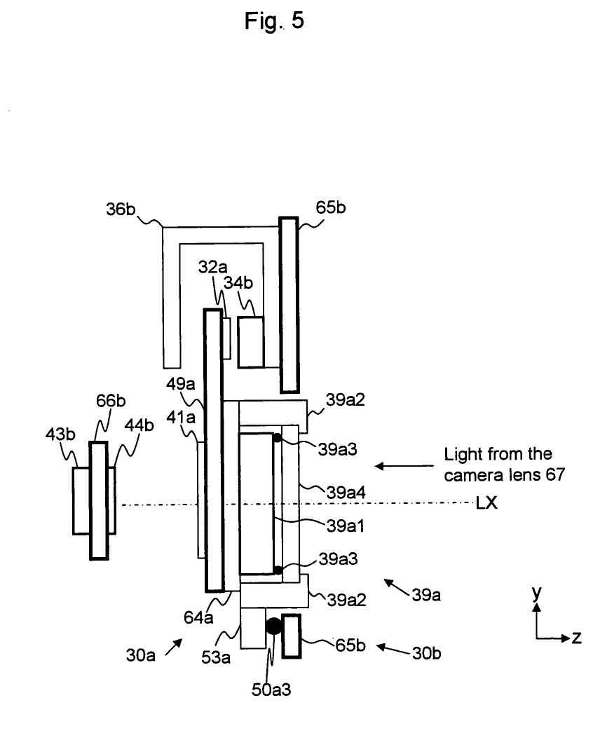

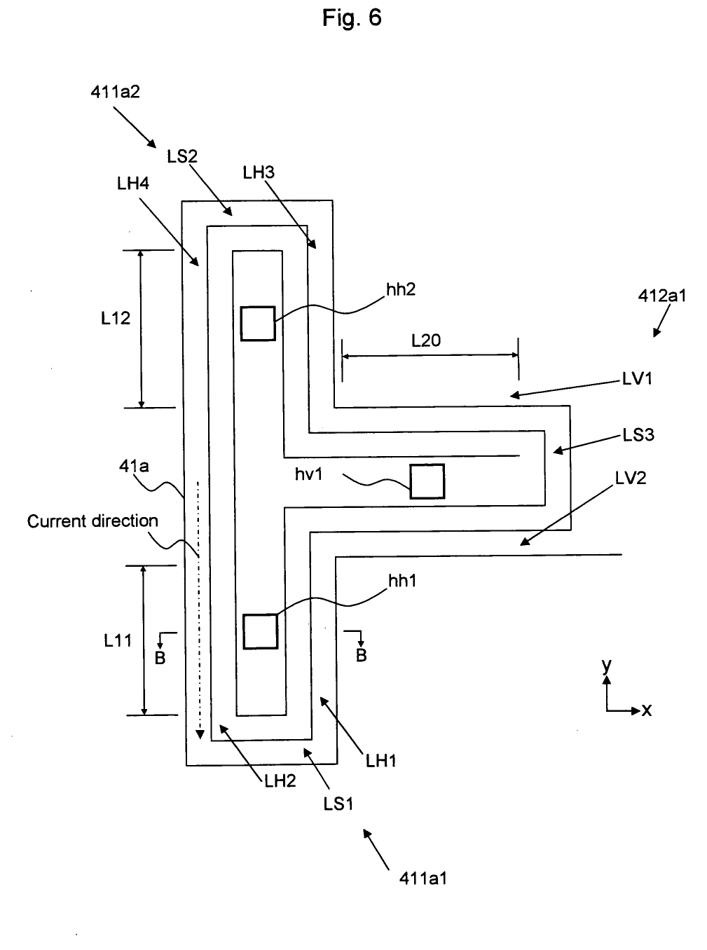

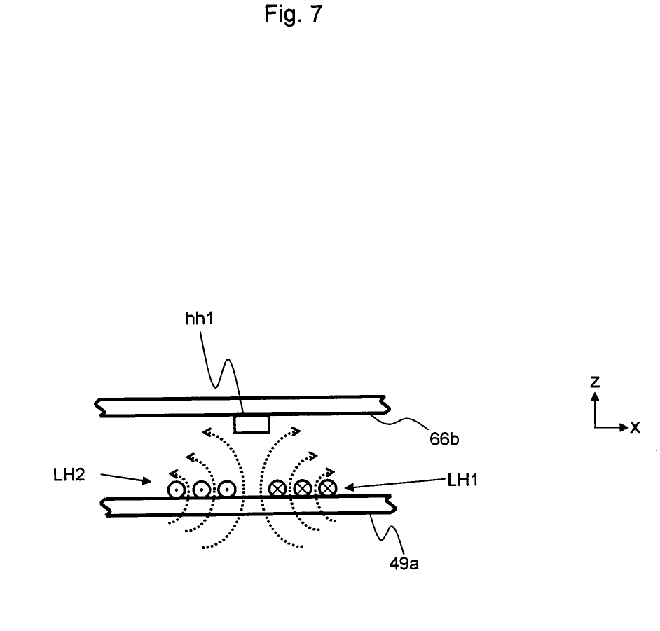

FIG. 5 shows a construction diagram of the section along line A-A of FIG. 4. FIG. 7 shows a construction diagram of the section along line B-B of FIG. 6.

The imaging part of the photographing apparatus 1 comprises a Pon button 11, a Pon switch 11a, a photometric switch 12a, a release button 13, a release switch 13a, an indicating unit 17 such as an LCD monitor etc., a CPU 21, an imaging block 22, an AE (automatic exposure) unit 23, an AF (automatic focusing) unit 24, an imaging unit 39a in the anti-shake apparatus 30, and a camera lens 67 (see FIGS. 1, 2, and 3).

Whether the Pon switch 11a is in the on state or the off state, is determined by a state of the Pon button 11, so that the on/off states of the photographing apparatus 1 are changed corresponding to the of/off states of the Pon switch 11a.

The photographic subject image is taken as an optical image through the camera lens 67 by the imaging block 22, which drives the imaging unit 39a, so that the image, which is taken, is indicated on the indicating unit 17. The photographic subject image can be optically observed by the optical finder (not depicted).

When the release button 13 is half pushed by the operator, the photometric switch 12a changes to the on state, so that the photometric operation, the AF sensing operation, and the focusing operation are performed.

When the release button 13 is fully pushed by the operator, the release switch 13a changes to the on state, so that the imaging operation is performed, and the image, which is taken, is stored.

The CPU 21 is a control apparatus, which controls each part of the photographing apparatus 1 regarding the imaging operation, and controls each part of the photographing apparatus 1 regarding the anti-shake operation. The anti-shake operation controls the movement of the movable unit 30a and controls detecting the position of the movable unit 30a.

The imaging block 22 drives the imaging unit 39a. The AE unit 23 performs the photometric operation for the photographic subject, calculates the photometric values, and calculates the aperture value and the time length of the exposure time, which is needed for imaging, corresponding to the photometric values. The AF unit 24 performs the AF sensing operation, and performs the focusing operation, which is needed for the imaging, corresponding to the result of the AF sensing operation. In the focusing operation, the position of the camera lens 67 is moved in the optical axis LX direction.

The anti-shaking part of the photographing apparatus 1 comprises an anti-shake button 14, an anti-shake switch 14a, a CPU 21, an angular velocity detecting unit 25, a first driver circuit 29, an anti-shake apparatus 30, a first hall-element signal-processing unit 45, a second driver circuit 48, and the camera lens 67.

When the anti-shake button 14 is fully pushed by the operator, the anti-shake switch 14a changes to the on state, so that the anti-shake operation is performed where the angular velocity detecting unit 25 and the anti-shake apparatus 30 are driven, at every predetermined time interval, independently of the other operations which include the photometric operation etc.

The various output commands corresponding to the input signals of these switches are controlled by the CPU 21.

The information regarding whether the photometric switch 12a is in the on state or in the off state, is input to port P12 of the CPU 21 as a 1-bit digital signal. The information regarding whether the release switch 13a is in the on state or in the off state, is input to port P13 of the CPU 21 as a 1-bit digital signal. The information regarding whether the anti-shake switch 14a is in the on state or in the off state, is input to port P14 of the CPU 21 as a 1-bit digital signal.

The imaging block 22 is connected to port P3 of the CPU 21 for inputting and outputting signals. The AE unit 23 is connected to port P4 of the CPU 21 for inputting and outputting signals. The AF unit 24 is connected to port P5 of the CPU 21 for inputting and outputting signals.

Next, the details of the input and output relationship with the CPU 21 for the angular velocity unit 25, the first driver circuit 29, the anti-shake apparatus 30, the first hall-element signal-processing unit 45, and the second driver circuit 48, are explained.

The angular velocity unit 25 has a first angular velocity sensor 26a, a second angular velocity sensor 26b, and a combined amplifier and high-pass filter circuit 28. The first angular velocity sensor 26a detects the velocity-component in the first direction x of the angular velocity of the photographing apparatus 1, at every predetermined time interval (1 ms). The second angular velocity sensor 26b detects the velocity-component in the second direction y of the angular velocity of the photographing apparatus 1, at every predetermined time interval (1 ms).

The combined amplifier and high-pass filter circuit 28 amplifies the signal regarding the first direction x of the angular velocity (the velocity-component in the first direction x of the angular velocity), reduces a null voltage and a panning of the first angular velocity sensor 26a, and outputs the analogue signal to the A/D converter A/D 0 of the CPU 21 as a first angular velocity vx.

The combined amplifier and high-pass filter circuit 28 amplifies the signal regarding the second direction y of the angular velocity (the velocity-component in the second direction y of the angular velocity), reduces a null voltage and a panning of the second angular velocity sensor 26b, and outputs the analogue signal to the A/D converter A/D 1 of the CPU 21 as a second angular velocity vy.

The angular velocity unit 25 also has a third angular velocity sensor 26c. The third angular velocity sensor 26c detects the rotation-velocity-component of the angular velocity on an xy plane of the photographing apparatus 1, at every predetermined time interval (1 ms). The xy plane is a plane which is perpendicular to the third direction z.

The combined amplifier and high-pass filter circuit 28 amplifies the signal regarding the rotation-speed of the angular velocity (the rotation-velocity-component on the xy plane of the angular velocity), reduces a null voltage and a panning of the third angular velocity sensor 26c, and outputs the analogue signal to the A/D converter A/D 2 of the CPU 21 as a third angular velocity v@.

The CPU 21 converts the first angular velocity vx which is input to the A/D converter A/D 0, and the second angular velocity vy which is input to the A/D converter A/D 1, and the third angular velocity vO which is input to the A/D converter A/D 2, to digital signals (A/D converting operation), and calculates the hand-shake quantity, which occurs in the predetermined time (1 ms), on the basis of the converted digital signals and the converting coefficient, where focal distance is considered. This hand-shake quantity includes a component in the first direction x, a component in the second direction y, and a rotation-component on the xy plane. Accordingly, the CPU 21 and the angular velocity detecting unit 25 have a function which calculates the hand-shake quantity.

The CPU 21 calculates the position S of the imaging unit 39a (the movable unit 30a), which should be moved to and rotated to, corresponding to the hand-shake quantity which is calculated, for the first direction x, the second direction y, and the rotation angle.

The location in the first direction x of the position S is defined as sx, and the location in the second direction y of the position S is defined as sy, and the rotation angle on the xy plane of the position S is defined as sθ. The movement of the movable unit 30a, which includes the imaging unit 39a, is performed by using electro-magnetic force and is described later. The driving force D, which drives the first driver circuit 29 in order to move and rotate the movable unit 30a to the position S, has a first PWM duty dx as the driving-force component in the first direction x, and a second PWM duty dy1 as one of the driving-force components in the second direction y, and a third PWM duty dy2 as another of the driving-force components in the second direction y.

The anti-shake apparatus 30 is an apparatus which corrects the hand-shake effect, by moving and rotating the imaging unit 39a to the position S, by canceling lag of the photographic subject image on the imaging surface of the imaging device 39a1, and by stabilizing the photographing subject image that reaches the imaging surface of the imaging device 39a1. This lag includes a rotation-component.

The anti-shake apparatus 30 has a movable unit 30a, which includes the imaging unit 39a, and a fixed unit 30b. Or, the anti-shake apparatus 30 is composed of a driving part which moves the movable unit 30a by electro-magnetic force to the position S, and a position-detecting part which detects the position of the movable unit 30a (a detected-position P).

The size and the direction of the electro-magnetic force are determined by the size and the direction of the current which flows in the coil, and the size and the direction of the magnetic-field of the magnet.

The driving of the movable unit 30a of the anti-shake apparatus 30, is performed by the first driver circuit 29 which has the first PWM duty dx input from the PWM 0 of the CPU 21 and has the second PWM duty dy1 input from the PWM 1 of the CPU 21 and has the third PWM duty dy2 input from the PWM 2 of the CPU 21.

The detected-position P of the movable unit 30a, either before moving and rotating or after moving and rotating, which is moved and rotated by driving the first driver circuit 29, is detected by the first hall element unit 44b and the first hall-element signal-processing unit 45.

Information in the first direction x for the detected-position P, in other words first and second horizontal detected-position signals px1 and px2 are input to the A/b converters A/D 3 and A/D 4 of the CPU 21. The first horizontal detected-position signal px1 is an analogue signal, and is converted to a digital signal through the A/D converter A/D 3 (A/D converting operation). The second horizontal detected-position signal px2 is an analogue signal, and is converted to a digital signal through the A/D converter A/D 4 (A/D converting operation).

Information in the second direction y for the detected-position P, in other words a vertical detected-position signal py is input to the A/D converter A/D 5 of the CPU 21. The vertical detected-position signal py is an analogue signal, and is converted to a digital signal through the A/D converter A/D 5 (A/D converting operation).

A first data in the first direction x for the detected-position P, after the A/D converting operation, is defined as pdx1, corresponding to the first horizontal detected-position signal px1.

A second data in the first direction x for the detected-position P, after the A/D converting operation, is defined as pdx2, corresponding to the second horizontal detected-position signal px2.

A data in the second direction y for the detected-position P, after the A/D converting operation, is defined as pdy, corresponding to the vertical detected-position signal py.

A first location in the first direction x for the detected-position P, after the calculating operation for the data pdx1, pdx2, and pdy, is defined as pxx.

A second location in the second direction y for the detected-position P, after the calculating operation for the data pdx1, pdx2, and pdy, is defined as pyy.

A rotation angle on the xy plane for the detected-position P, after the calculating operation for the data pdx1, pdx2, and pdy, is defined as pe.

The PID (Proportional Integral Differential) control is performed on the basis of the data for the detected-position P (pxx, pyy, pθ) and the data for the position S (sx, sy, se) which should be moved to and rotated to.

The movable unit 30a has a first vertical driving coil 31a1, a second vertical driving coil 31a2, a horizontal driving coil 32a, an imaging unit 39a, a first position-detecting coil 41a, a movable circuit board 49a, a first ball for movement 50a1, a second ball for movement 50a2, a third ball for movement 50a3, a first ball-bearing for movement 51a, a second ball-bearing for movement 52a, a third ball-bearing for movement 53a, and a plate 64a (see FIGS. 4 and 5).

The fixed unit 30b has a first vertical driving magnet 33b1, a second vertical driving magnet 33b2, a horizontal driving magnet 34b, a first vertical driving yoke 35b1, a second vertical driving yoke 35b2, a horizontal driving yoke 36b, a position-detecting yoke 43b, a first hall element unit 44b, a base board 65b, and a sensor circuit board 66b.

The movable unit 30a contacts the fixed unit 30b, through the first, second, and third balls 50a1, 50a2, and 50a3. The first ball for movement 50a1 can roll between the first ball-bearing for movement 51a and the base board 65b. The second ball for movement 50a2 can roll between the second ball-bearing for movement 52a and the base board 65b. The third ball for movement 50a3 can roll between the third ball-bearing for movement 53a and the base board 65b.

The contacted situation of the movable unit 30a and the fixed unit 30b is kept through the first, second, and third balls 50a1, 50a2, and 50a3.

The movable unit 30a is urged in the third direction z, by an urging member such as a spring etc., which is fixed in the photographing apparatus 1. Therefore, the movable and rotatable situation of the movable unit 30a on the xy plane is kept. Or, the fixed unit 30b supports the movable unit 30a with the movable and rotatable situation.

When the center area of the imaging device 39a1 is located on the optical axis LX of the camera lens 67, the location relation between the movable unit 30a and the fixed unit 30b is set up so that the movable unit 30a is located at the center of its movement range in both the first direction x and the second direction y, in order to utilize the full size of the imaging range of the imaging device 39a1.

A rectangle shape, which forms the imaging surface (the valid pixel area) of the imaging device 39a1, has two diagonal lines. In the first embodiment, the center of the imaging device 39a1 is the crossing point of these two diagonal lines.

Four segments of the rectangular shape are parallel to the first direction x or the second direction y, before the movable unit 30a is rotated.

In the first embodiment, the center of the imaging device 39a1 agrees with the center of gravity of the rectangle shape of the valid pixel area. Accordingly, when the movable unit 30a is located at the center of its movement range, the center of gravity of the rectangle shape of the valid pixel area is located on the optical axis LX of the camera lens 67.

The imaging unit 39a, the plate 64a, and the movable circuit board 49a are attached, in this order along the optical axis LX direction, viewed from the side of the camera lens 67. The imaging unit 39a has an imaging device 39a1 (such as a CCD or a COMS etc.), a stage 39a2, a holding unit 39a3, and an optical low-pass filter 39a4. The stage 39a2 and the plate 64a hold and urge the imaging device 39a1, the holding unit 39a3, and the optical low-pass filter 39a4 in the optical axis LX direction.

The first, second, and third ball-bearings 51a, 52a, and 53a are attached to the stage 39a2. The imaging device 39a1 is attached to the plate 64a, so that positioning of the imaging device 39a1 is performed where the imaging device 39a1 is perpendicular to the optical axis LX of the camera lens 67. In the case where the plate 64a is made of a metallic material, the plate 64a has the effect of radiating heat from the imaging device 39a1, by contacting the imaging device 39a1.

The first vertical driving coil 31a1, the second vertical driving coil 31a2, the horizontal driving coil 32a, and the first position-detecting coil 41a are attached to the movable circuit board 49a.

The first vertical driving coil 31a1 forms a seat and a spiral shape coil pattern. The coil pattern of the first vertical driving coil 31a1 has lines which are parallel to the first direction x, before the movable unit 30a is rotated. The movable unit 30a which includes the first vertical driving coil 31a1, is moved in the second direction y, by the first electromagnetic force. The lines which are parallel to the first direction x, are used for moving the movable unit 30a in the second direction y. The lines which are parallel to the first direction x, have a first effective length L1.

The first electro-magnetic force occurs on the basis of the current direction of the first vertical driving coil 31a1 and the magnetic-field direction of the first vertical driving magnet 33b1.

The second vertical driving coil 31a2 forms a seat and a spiral shape coil pattern. The coil pattern of the second vertical driving coil 31a2 has lines which are parallel to the first direction x, before the movable unit 30a is rotated. The movable unit 30a which includes the second vertical driving coil 31a2, is moved in the second direction y, by the second electro-magnetic force. The lines which are parallel to the first direction x, are used for moving the movable unit 30a in the second direction y. The lines which are parallel to the first direction x, have a second effective length L2.

The second electromagnetic force occurs on the basis of the current direction of the second vertical driving coil 31a2 and the magnetic-field direction of the second vertical driving magnet 33b2.

The horizontal driving coil 32a forms a seat and a spiral shape coil pattern. The coil pattern of the horizontal driving coil 32a has lines which are parallel to the second direction y, before the movable unit 30a is rotated. The movable unit 30a which includes the horizontal driving coil 32a, is moved in the first direction x, by the third electromagnetic force. The lines which are parallel to the second direction y, are used for moving the movable unit 30a in the first direction x. The lines which are parallel to the second direction y, have a third effective length L3.

The third electromagnetic force occurs on the basis of the current direction of the horizontal driving coil 32a and the magnetic-field direction of the horizontal driving magnet 34b.

Because the two coils (31a1 and 31a2) are used for moving the movable unit 30a in the second direction y and because the movable unit 30a is movable and rotatable on the xy plane relative to the fixed unit 30b by the first, second, and third balls 50a1, 50a2, and 50a3, the movable unit 30a can be moved and rotated on the xy plane by the first and second vertical driving coils 31a1 and 31a2 and the horizontal driving coil 32a, relative to the fixed unit 30b.

In the first embodiment, the first vertical driving coil 31a1 is attached to the right edge area of the movable circuit board 49a (one of the edge areas of the movable circuit board 49a in the first direction x), viewed from the third direction z and the opposite side of the camera lens 67.

Similarly, the second vertical driving coil 31a2 is attached to the left edge area of the movable circuit board 49a (another of the edge areas of the movable circuit board 49a in the first direction x), viewed from the third direction z and the opposite side of the camera lens 67.

Similarly, the horizontal driving coil 32a is attached to the upper area of the movable circuit board 49a (one of the edge areas of the movable circuit board 49a in the second direction y), viewed from the third direction z and the opposite side of the camera lens 67.

Further, the first position-detecting coil 41a is attached to the middle area of the movable circuit board 49a between the first and second vertical driving coils 31a1 and 31a2, in the first direction x.

The imaging device 39a1 is attached to the middle area of the movable circuit board 49a between the first and second vertical driving coils 31a1 and 31a2, in the first direction x.

The first and second vertical driving coils 31a1 and 31a2 and the horizontal driving coil 32a, and the imaging device 39a1 are attached on the same side of the movable circuit board 49a. The first position-detecting coil 41a is attached on the opposite side of the movable circuit board 49a to the first vertical driving coil 31a1.

The first and second vertical driving coils 31a1 and 31a2 and the horizontal driving coil 32a are connected with the first driver circuit 29 which drives the first and second vertical driving coils 31a1 and 31a2 and the horizontal driving coil 32a through the flexible circuit board (not depicted). The first PWM duty dx is input to the first driver circuit 29 from the PWM 0 of the CPU 21, and the second PWM duty dy1 is input to the first driver circuit 29 from the PWM 1 of the CPU 21, and the third PWM duty dy2 is input to the first driver circuit 29 from the PWM 2 of the CPU 21. The first driver circuit 29 supplies power to the horizontal driving coil 32a corresponding to the value of the first PWM duty dx, and to the first vertical driving coil 31a1 corresponding to the value of the second PWM duty dy1, and to the second vertical driving coil 31a2 corresponding to the value of the third PWM duty dy2, to drive (move and rotate) the movable unit 30a.

The first position-detecting coil 41a is a coil which forms a seat and spiral shape coil pattern. The first position-detecting coil 41a is one coil which has a first horizontal position-detecting area 411a1 and a second horizontal position-detecting area 411a2 and a vertical position-detecting area 412a1. The first and second horizontal position-detecting areas 411a1 and 411a2 are used for detecting a position of the movable unit 30a in the first direction x. The vertical position-detecting area 412a1 is used for detecting a position of the movable unit 30a in the second direction y.

The first horizontal position-detecting area 411al has first horizontal position-detecting segments LH1, second horizontal position-detecting segments LH2, and first short-segments LS1.

The first and second horizontal position-detecting segments LH1 and LH2 and the first short-segments LS1 are parts of the first position-detecting coil 41a, and face the first horizontal hall element hh1 of the first hall element unit 44b which is described later. The first and second horizontal position-detecting segments LH1 and LH2 are parallel to the second direction y, before the movable unit 30a is rotated.

The direction of the current through the first horizontal position-detecting segments LH1 is opposite to the direction of the current through the second horizontal position-detecting segments LH2.

The first short-segments LS1 are parallel to the first direction x, and are connected with the first and second horizontal position-detecting segments LH1 and LH2.

The second horizontal position-detecting area 411a2 has third horizontal position-detecting segments LH3, fourth horizontal position-detecting segments LH4, and second short-segments LS2.

The third and fourth horizontal position-detecting segments LH3 and LH4 and the second short-segments LS2 are parts of the first position-detecting coil 41a, and face the second horizontal hall element hh2 of the first hall element unit 44b which is described later. The third and fourth horizontal position-detecting segments LH3 and LH4 are parallel to the second direction y, before the movable unit 30a is rotated.

The direction of the current through the third horizontal position-detecting segments LH3 is opposite to the direction of the current through the fourth horizontal position-detecting segments LH4.

The second short-segments LS2 are parallel to the first direction x, and are connected with the third and fourth horizontal position-detecting segments LH3 and LH4.

The vertical position-detecting area 412a1 has first vertical position-detecting segments LV1, second vertical position-detecting segments LV2, and third short-segments LS3. The first and second vertical position-detecting segments LV1 and LV2 and the third short-segments LS3 are parts of the first position-detecting coil 41a, and face the vertical hall element hv1 of the first hall element unit 44b which is described later. The first and second vertical position-detecting segments LV1 and LV2 are parallel to the first direction x, before the movable unit 30a is rotated.

The direction of the current through the first vertical position-detecting segments LV1 is opposite to the direction of the current through the second vertical position-detecting segments LV2.

The third short-segments LS3 are parallel to the second direction y, and are connected with the first and second vertical position-detecting segments LV1 and LV2.

The first, second, third and fourth horizontal position-detecting segments LH1, LH2, LH3, and LH4 and the first and second vertical position-detecting segments LV1 and LV2 are composed of coil segments. The number of segments is the same as the number of times the first position-detecting coil 41a is wound round.

The number of times the first position-detecting coil 41a is wound round is in integers of 1 or more, so that the number of segments of the first, second, third and fourth horizontal position-detecting segments LH1, LH2, LH3, and LH4 and the first and second vertical position-detecting segments LV1 and LV2 is equal to 1 or integers greater than 1.

In the first embodiment, the number of times the first position-detecting coil 41a is wound round is 3, so that the number of first, second, third and fourth horizontal position-detecting segments LH1, LH2, LH3, and LH4 and the number of first and second vertical position-detecting segments LV1 and LV2 is 3 (see FIGS. 6 and 7).

Magnetic-fields are generated radially around the first horizontal position-detecting segments LH1, on the basis of the current which flows through the first horizontal position-detecting segments LH1 (the first position-detecting coil 41a).

Magnetic-fields are generated radially around the second horizontal position-detecting segments LH2, on the basis of the current which flows through the second horizontal position-detecting segments LH2 (the first position-detecting coil 41a).

The direction of the magnetic-fields, which are generated around the first and second horizontal position-detecting segments LH1 and LH2, is almost parallel to the third direction z, near the first horizontal hall element hh1.

FIG. 7 shows lines of magnetic force on the basis of the magnetic-fields, which flow from the movable circuit board 49a to the sensor circuit board 66b.

Magnetic-fields are generated radially around the third horizontal position-detecting segments LH3, on the basis of the current which flows through the third horizontal position-detecting segments LH3 (the first position-detecting coil 41a).

Magnetic-fields are generated radially around the fourth horizontal position-detecting segments LH4, on the basis of the current which flows through the fourth horizontal position-detecting segments LH4 (the first position-detecting coil 41a).

The direction of the magnetic-fields, which are generated around the third and fourth horizontal position-detecting segments LH3 and LH4, is almost parallel to the third direction z, near the second horizontal hall element hh2.

Magnetic-fields are generated radially around the first vertical position-detecting segments LV1, on the basis of the current which flows through the first vertical position-detecting segments LV1 (the first position-detecting coil 41a).

Magnetic-fields are generated radially around the second vertical position-detecting segments LV2, on the basis of the current which flows through the second vertical position-detecting segments LV2 (the first position-detecting coil 41a).

The direction of the magnetic-fields, which are generated around the first and second vertical position-detecting segments LV1 and LV2, is almost parallel to the third direction z, near the vertical hall element hv1.

The first and second horizontal position-detecting segments LH1 and LH2 have a first horizontal effective position-detecting length L11, where the magnetic-field, which is formed from the magnetic-fields which are generated radially around the first and second horizontal position-detecting segments LH1 and LH2, and which influences the first horizontal hall element hh1, is not changed during movement of the movable unit 30a in the second direction y. The first horizontal effective position-detecting length L11 is longer than the movement range of the movable unit 30a in the second direction y.

The third and fourth horizontal position-detecting segments LH3 and LH4 have a second horizontal effective position-detecting length L12, where the magnetic-field, which is formed from the magnetic-fields which are generated radially around the third and fourth horizontal position-detecting segments LH3 and LH4, and which influences the second horizontal hall element hh2, is not changed during movement of the movable unit 30a in the second direction y. The second horizontal effective position-detecting length L12 is longer than the movement range of the movable unit 30a in the second direction y.

The first and second vertical position-detecting segments LV1 and LV2 have a vertical effective position-detecting length L20, where the magnetic-field, which is formed from the magnetic-fields which are generated radially around the first and second vertical position-detecting segments LV1 and LV2, and which influences the vertical hall element hv1, is not changed during movement of the movable unit 30a in the first direction x. The vertical effective position-detecting length L20 is longer than the movement range of the movable unit 30a in the first direction x.

The lengths of the parts such as the first, second, and third short-segments LS1, LS2, and LS3, (the parts other than the first, second, third, and fourth horizontal position-detecting segments LH1, LH2, LH3, and LH4 and the first and second vertical position-detecting segments LV1 and LV2) of the first position-detecting coil 41a, are shorter than the first and second horizontal effective position-detecting lengths L11 and L12 and the vertical effective position-detecting length L20.

Further, the lengths of the first short-segments LS1 are longer than the movement range of the first horizontal hall element hh1 (the movable unit 30a) in the first direction x.

Similarly, the lengths of the second short-segments LS2 are longer than the movement range of the second horizontal hall element hh2 (the movable unit 30a) in the first direction x.

Similarly, the lengths of the third short-segment LS3 are longer than the movement range of the vertical hall element hv1 (the movable unit 30a) in the second direction y.

Accordingly, the first short-segments LS1 generate magnetic-fields when current flows through the first short-segments LS1 (the first position-detecting coil 41a), however, the influence of the magnetic-field which is formed from the magnetic-fields which are generated radially around the first short-segments LS1, on the first horizontal hall element hh1, can be restrained, in comparison with the influence of the magnetic-field which is formed from the magnetic-fields which are generated radially around the first and second horizontal position-detecting segments LH1 and LH2, on the first horizontal hall element hh1.

Similarly, the second short-segments LS2 generate magnetic-fields when current flows through the second short-segments LS2 (the first position-detecting coil 41a), however, the influence of the magnetic-field which is formed from the magnetic-fields which are generated radially around the second short-segments LS2, on the second horizontal hall element hh2, can be restrained, in comparison with the influence of the magnetic-field which is formed from the magnetic-fields which are generated radially around the third and fourth horizontal position-detecting segments LH3 and LH4, on the second horizontal hall element hh2.

Similarly, the third short-segments LS3 generate magnetic-fields when current flows through the third short-segments LS3 (the first position-detecting coil 41a), however, the influence of the magnetic-field which is formed from the magnetic-fields which are generated radially around the third short-segments LS3, on the vertical hall element hv1, can be restrained, in comparison with the influence of the magnetic-field which is formed from the magnetic-fields which are generated radially around the first and second vertical position-detecting segments LV1 and LV2, on the vertical hall element hv1.

Therefore, the position-detecting accuracy, when using the first, second, third, and fourth horizontal position-detecting segments LH1, LH2, LH3, LH4 and the first and second horizontal hall elements hh1 and hh2 and when using the first and second vertical position-detecting segments LV1 and LV2 and the vertical hall element hv1, can be improved in comparison with when the lengths of the first, second, and third short-segments LS1, LS2, and LS3 are not shorter than the first and second horizontal effective position-detecting lengths L11 and L12 and the vertical effective position-detecting length L20.

The outer circumference of the first position-detecting coil 41a forms a T character shape, viewed from the third direction z.

The first position-detecting coil 41a is attached on the opposite side of the movable circuit board 49a to the imaging unit 39a.

Further, the first position-detecting coil 41a and the imaging unit 39a are attached where a line which is parallel to the third direction z and which passes through the center area of the imaging device 39a1, passes through an intersection area of the two lines constituting this T character of the first position-detecting coil 41a. This is because the position-detecting accuracy is improved, as the position of the data for the detected-position P (pxx, pyy, pθ) which are calculated on the basis of the first and second horizontal detected-position signals px1 and px2 and the vertical detected-position signal py, becomes close to the center of the imaging device 39a1.

Accordingly, the movement quantity of the imaging device 39a1 in the movable unit 30a, becomes nearly equal to the movement quantity of the position-detecting member (or the first position-detecting coil 41a) in the movable unit 30a. The movement quantity includes the rotating angle.

The first horizontal position-detecting area 411a1 forms the left side part of the upper lateral line part that forms the T character. The second horizontal position-detecting area 411a2 forms the right side part of the upper lateral line part that forms the T character. The vertical position-detecting area 412a1 forms the longitudinal line part that forms The T character.

Because the first position-detecting coil 41a has a seat and spiral shape coil pattern, the thickness of the first position-detecting coil 41a, in the third direction z, can be thinned down in the third direction z, in comparison with when the permanent magnet is used as the magnetic-field generating apparatus for detecting the position of the movable unit 30a.

Therefore, it is possible to reduce the size of the anti-shake apparatus 30, by reducing the distance between the movable unit 30a and the fixed unit 30b in the third direction z.

Further, the first position-detecting coil 41a may consist of a plurality of seat coils which are layered in the third direction z. Even if the first position-detecting coil 41a consists of some seat coils which are layered in the third direction z, the thickness of the first position-detecting coil 41a is not increased in the third direction z, however, the number of times the first position-detecting coil 41a is wound round can be increased, so that the magnetic-flux density between the first position-detecting coil 41a and the first hall element unit 44b can be raised, and position-detecting accuracy can be improved.

The first position-detecting coil 41a is connected with the second driver circuit 48, which drives the first position-detecting coil 41a, through the flexible circuit board (not depicted). The second driver circuit 48 determines the supply of electricity to the first position-detecting coil 41a, on the basis of the on state of the signal output from the port P50 of the CPU 21, and stops the supply of electricity to the first position-detecting coil 41a, on the basis of the off state of the signal output from the port P50 of the CPU 21.

The first vertical driving magnet 33b1 is attached to the movable unit side of the fixed unit 30b, where the first vertical driving magnet 33b1 faces the first vertical driving coil 31a1 in the third direction z.

The second vertical driving magnet 33b2 is attached to the movable unit side of the fixed unit 30b, where the second vertical driving magnet 33b2 faces the second vertical driving coil 31a2 in the third direction z.

The horizontal driving magnet 34b is attached to the movable unit side of the fixed unit 30b, where the horizontal driving magnet 34b faces the horizontal driving coil 32a in the third direction z.

The first hall element unit 44b is attached to the movable unit side of the fixed unit 30b, where the first hall element unit 44b faces the first position-detecting coil 41a in the third direction z.

The position-detecting yoke 43b is attached to a back surface side of the fixed unit 30b, which is the opposite side to the surface having the first hall element unit 44b. The position-detecting yoke 43b is made of a magnetic material, and raises the magnetic-flux density between the first position-detecting coil 41a and the first hall element unit 44b.

The first vertical driving magnet 33b1 is attached to the first vertical driving yoke 35b1, under the condition where the N pole and S pole are arranged in the second direction y. The first vertical driving yoke 35b1 is attached to the base board 65b of the fixed unit 30b, on the side of the movable unit 30a, in the third direction z.

The length of the first vertical driving magnet 33b1 in the first direction x, is longer in comparison with the first effective length L1 of the first vertical driving coil 31a1. The magnetic-field which influences the first vertical driving coil 31a1, is not changed during movement of the movable unit 30a in the first direction x.

The second vertical driving magnet 33b2 is attached to the second vertical driving yoke 35b2, under the condition where the N pole and S pole are arranged in the second direction y. The second vertical driving yoke 35b2 is attached to the base board 65b of the fixed unit 30b, on the side of the movable unit 30a, in the third direction Z.

The length of the second vertical driving magnet 33b2 in the first direction x, is longer in comparison with the second effective length L2 of the second vertical driving coil 31a2. The magnetic-field which influences the second vertical driving coil 31a2, is not change during movement of the movable unit 30a in the first direction x.

The horizontal driving magnet 34b is attached to the horizontal driving yoke 36b, under the condition where the N pole and S pole are arranged in the first direction x. The horizontal driving yoke 36b is attached to the base board 65b of the fixed unit 30b, on the side of the movable unit 30a, in the third direction z.

The length of the horizontal driving magnet 34b in the second direction y, is longer in comparison with the third effective length L3 of the horizontal driving coil 32a. The magnetic-field which influences the horizontal driving coil 32a, is not changed during movement of the movable unit 30a in the second direction y.

The first vertical driving yoke 35b1 is made of a soft magnetic material, and forms a square-u-shape channel when viewed from the first direction x. The first vertical driving magnet 33b1 and the first vertical driving coil 31a1 are inside the channel of the first vertical driving yoke 35b1.

The side of the first vertical driving yoke 35b1, which contacts the first vertical driving magnet 33b1, prevents the magnetic-field of the first vertical driving magnet 33b1 from leaking to the surroundings.

The other side of the first vertical driving yoke 35b1 (which faces the first vertical driving magnet 33b1, the first vertical driving coil 31a1, and the movable circuit board 49a) raises the magnetic-flux density between the first vertical driving magnet 33b1 and the first vertical driving coil 31a1.

The second vertical driving yoke 35b2 is made of a soft magnetic material, and forms a square-u-shape channel when viewed from the first direction x. The second vertical driving magnet 33b2 and the second vertical driving coil 31a2 are inside the channel of the second vertical driving yoke 35b2.

The side of the second vertical driving yoke 35b2, which contacts the second vertical driving magnet 33b2, prevents the magnetic-field of the second vertical driving magnet 33b2 from leaking to the surroundings.

The other side of the second vertical driving yoke 35b2 (which faces the second vertical driving magnet 33b2, the second vertical driving coil 31a2, and the movable circuit board 49a) raises the magnetic-flux density between the second vertical driving magnet 33b2 and the second vertical driving coil 31a2.

The horizontal driving yoke 36b is made of a soft magnetic material, and forms a square-u-shape channel when viewed from the first direction x. The horizontal driving magnet 34b and the horizontal driving coil 32a are inside the channel of the horizontal driving yoke 36b.

The side of the horizontal driving yoke 36b, which contacts the horizontal driving magnet 34b, prevents the magnetic-field of the horizontal driving magnet 34b from leaking to the surroundings.

The other side of the horizontal driving yoke 36b (which faces the horizontal driving magnet 34b, the horizontal driving coil 32a, and the movable circuit board 49a) raises the magnetic-flux density between the horizontal driving magnet 34b and the horizontal driving coil 32a.

The first hall element unit 44b is a one-axis hall element which has three hall elements that are magnetoelectric converting elements (magnetic-field change-detecting elements) using the Hall Effect. The first hall element unit 44b detects the first horizontal detected-position signal px1, and the second horizontal detected-position signal px2, and the vertical detected-position signal py.

One of the three hall elements is a first horizontal hall element hh1 for detecting the first horizontal detected-position signal px1, and one of three hall elements is a second horizontal hall element hh2 for detecting the second horizontal detected-position signal px2, so that the other is a vertical hall element hv1 for detecting the vertical detected-position signal py (see FIG. 6).

The first horizontal hall element hh1 is attached to the sensor circuit board 66b of the fixed unit 30b, under the condition where the first horizontal hall element hh1 faces the first horizontal position-detecting area 411a1 of the first position-detecting coil 41a of the movable unit 30a, in the third direction z.

The second horizontal hall element hh2 is attached to the sensor circuit board 66b of the fixed unit 30b, under the condition where the second horizontal hall element hh2 faces the second horizontal position-detecting area 411a2 of the first position-detecting coil 41a of the movable unit 30a, in the third direction z.

The vertical hall element hv1 is attached to the sensor circuit board 66b of the fixed unit 30b, under the condition where the vertical hall element hv1 faces the vertical position-detecting area 412a1 of the first position-detecting coil 41a of the movable unit 30a, in the third direction z.

When the center of the imaging device 39a1, passes through the optical axis LX before the movable unit 30a is rotated, it is desirable that the first horizontal hall element hh1 is located at a place on the first hall element unit 44b which faces an intermediate area between the first and second horizontal position-detecting segments LH1 and LH2 of the first position-detecting coil 41a in the first direction x, to perform the position-detecting operation utilizing the full size of the first horizontal position-detecting area 411a1.

Further, when the center of the imaging device 39a1, passes through the optical axis LX before the movable unit 30a is rotated, it is desirable that the first horizontal hall element hh1 is located at a place on the first hall element unit 44b which faces an intermediate area of the first horizontal position-detecting segments LH1 (or the second horizontal position-detecting segments LH2) in the second direction y, in other words, which faces an intermediate area of the segments which form the first horizontal effective position-detecting length L11.

Similarly, when the center of the imaging device 39a1, passes through the optical axis LX before the movable unit 30a is rotated, it is desirable that the second horizontal hall element hh2 is located at a place on the first hall element unit 44b which faces an intermediate area between the third and fourth horizontal position-detecting segments LH3 and LH4 of the first position-detecting coil 41a in the first direction x, to perform the position-detecting operation utilizing the full size of the second horizontal position-detecting area 411a2.

Further, when the center of the imaging device 39a1, passes through the optical axis LX before the movable unit 30a is rotated, it is desirable that the second horizontal hall element hh2 is located at a place on the first hall element unit 44b which faces an intermediate area of the third horizontal position-detecting segments LH3 (or the fourth horizontal position-detecting segments LH4) in the second direction y, in other words, which faces an intermediate area of the segments which form the second horizontal effective position-detecting length L12.

Similarly, when the center of the imaging device 39a1, passes through the optical axis LX before the movable unit 30a is rotated, it is desirable that the vertical hall element hv1 is located at a place on the first hall element unit 44b which faces an intermediate area between the first and second vertical position-detecting segments LV1 and LV2 of the first position-detecting coil 41a in the second direction y, to perform the position-detecting operation utilizing the full size of the vertical position-detecting area 412a1.

Further, when the center of the imaging device 39a1, passes through the optical axis LX before the movable unit 30a is rotated, it is desirable that the vertical hall element hv1 is located at a place on the first hall element unit 44b which faces an intermediate area of the first vertical position-detecting segments LV1 (or the second vertical position-detecting segments LV2) in the first direction x, in other words, which faces an intermediate area of the segments which form the vertical effective position-detecting length L20.

Both the base board 65b and the sensor circuit board 66b are plate state members which become the base for attaching the first hall element unit 44b etc., and are arranged being parallel to the imaging surface of the imaging device 39a1. The sensor circuit board 66b is positioned such that the first position-detecting coil 41a is between the sensor circuit board 66b and the imaging device 39a1 in the third direction z (see FIG. 5).

In the first embodiment, the base board 65b is arranged at the side nearer to the camera lens 67 in comparison with the movable circuit board 49a, in the third direction z. However, the movable circuit board 49a may be arranged at the side nearer to the camera lens 67 in comparison with the base board 65b. In this case, the first and second vertical driving coils 31a1 and 31a2 and the horizontal driving coil 32a are arranged on the opposite side of the movable circuit board 49a to the camera lens 67, so that the first and second vertical driving magnets 33b1 and 33b2 and the horizontal driving magnet 34b are arranged on the same side of the movable circuit board 49a as the camera lens 67.

The first hall-element signal-processing unit 45 has a first hall-element signal-processing circuit 451 and a second hall-element signal-processing circuit 452 and a third hall-element signal-processing circuit 453.

The first hall-element signal-processing circuit 451 detects a first horizontal potential-difference between output terminals of the first horizontal hall element hh1, based on an output signal of the first horizontal hall element hh1.

The first hall-element signal-processing circuit 451 outputs the first horizontal detected-position signal px1 to the A/D converter A/D 3 of the CPU 21, on the basis of the first horizontal potential-difference. The first horizontal detected-position signal px1 specifies a location of the part of the movable unit 30a which faces the first horizontal hall element hh1, in the first direction x.

The second hall-element signal-processing circuit 452 detects a second horizontal potential-difference between output terminals of the second horizontal hall element hh2, based on an output signal of the second horizontal hall element hh2.

The second hall-element signal-processing circuit 452 outputs the second horizontal detected-position signal px2 to the A/D converter A/D 4 of the CPU 21, on the basis of the second horizontal potential-difference. The second horizontal detected-position signal px2 specifies a location of the part of the movable unit 30a which faces the second horizontal hall element hh2, in the first direction x.

The third hall-element signal-processing circuit 453 detects a vertical potential-difference between output terminals of the vertical hall element hv1, based on an output signal of the vertical hall element hv1.

The third hall-element signal-processing circuit 453 outputs the vertical detected-position signal py to the A/D converter A/D 5 of the CPU 21, on the basis of the vertical potential-difference. The vertical detected-position signal py specifies a location of the part of the movable unit 30a which faces the vertical hall element hv1, in the second direction y.

A first horizontal voltage XVf1 is applied to the input terminals of the first horizontal hall element hh1 through the first hall-element signal-processing circuit 451, from the D/A converter D/A 0 of the CPU 21, during the position-detecting operation.

A second horizontal voltage XVf2 is applied to the input terminals of the second horizontal hall element hh2 through the second hall-element signal-processing circuit 452, from the D/A converter D/A 1 of the CPU 21, during the position-detecting operation.

A vertical voltage YVf is applied to the input terminals of the vertical hall element hv1 through the third hall-element signal-processing circuit 453, from the D/A converter D/A 2 of the CPU 21, during the position-detecting operation.

In the first embodiment, the three hall elements (hh1,hh2 and hv1) are used for specifying the location of the movable unit 30a which includes the rotating angle.

By using two of the three hall elements (hh1 and hh2), the locations in the first direction x of the two points on the movable unit 30a are specified. By using another of the three hall elements (hv1), the location in the second direction y of the one point on the movable unit 30a is specified. The location of the movable unit 30a which includes the rotating angle on the xy plane, can be specified on the basis of these information regarding the locations in the first direction x of the two points and the location in the second direction y of the one point.

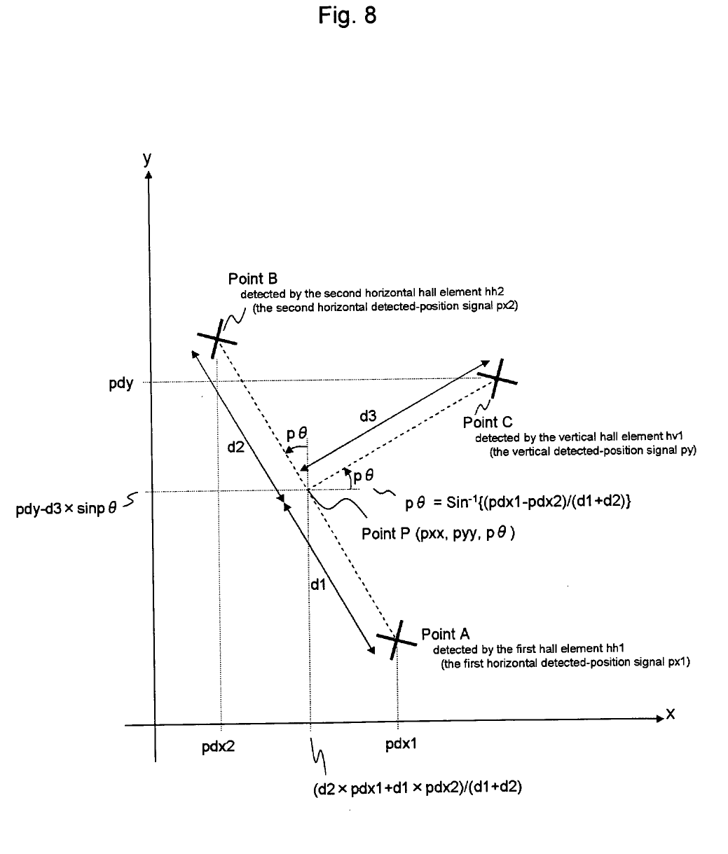

An example is explained using FIG. 8. The location of the point P (pxx, pyy, pθ) is calculated on the basis of the location-information of a point A, a point B, and a point C on the movable unit 30a. The point P is defined as an intersection point between a segment AB and a line which passes through the point C and which is perpendicular to the segment AB. The positions of the point A, the point B, and the point C are specified by the shape of the first position-detecting coil 41a. Accordingly, in the case where the first position-detecting coil 41a and the imaging unit 39a are attached to the movable circuit board 49a, and where the point P agrees with the center of the imaging device 39a1 in the third direction z, the location including rotating angle of the center of the imaging device 39a1 can be calculated by detecting the position P.

The location in the first direction x of the point A is detected by the first horizontal hall element hh1, as the first horizontal detected-position signal px1. The location in the first direction x of the point B is detected by the second horizontal hall element hh2, as the second horizontal detected-position signal px2. The location in the second direction y of the point C is detected by the vertical hall element hv1, as the vertical detected-position signal py.

The data for the position P (pxx, pyy, pθ) are calculated on the basis of the data pdx1 which is converted from the first horizontal detected-position signal px1 in the A/D converting operation, the data pdx2 which is converted from the second horizontal detected-position signal px2 in the A/D converting operation, and the data pdy which is converted from the vertical detected-position signal py in the A/D converting operation, a segment AP having length d1, a segment BP having length d2, and a segment CP having length d3, where pxx=(d2×pdx1+d1×pdx2)÷(d1+d2), pyy=pdy−d3×sin(pθ), and pθ=Sin⁻¹{(pdx1−pdx2)÷(d1+d2)}. The rotating angle pθ is an angle between the segment CP and the first direction x or between the segment AB and the second direction y.

In the first embodiment, because the position-detecting operation is performed by using a coil (the first position-detecting coil 41a) and a hall element, the weight of the anti-shake apparatus 30 can be reduced, in comparison with when the position-detecting operation is performed by using a permanent magnet and a hall element.

Generally, the electrical parts attached to the movable unit 30a, are electrically connected with the fixed unit 30b etc., through the flexible circuit board etc. The number of the electrical connecting cables for a hall element is more than the number of the electrical connecting cables for a coil. In the first embodiment, because the hall element (the first hall element unit 44b) is attached to the fixed unit 30b and the coil (the first position-detecting coil 41a) is attached to the movable unit 30a, the number of the electrical connecting cables for the movable unit 30a can be restrained, in comparison with when the hall element is attached to the movable unit 30a. Or, it is possible to simplify electrical connections, and restrain external forces on the movable unit 30a. The external forces are the mechanical stresses and loads of driving of the movable unit 30a when moving the movable unit 30a etc. Therefore, the size of the anti-shake apparatus 30 can be reduced, and the response of the anti-shake apparatus 30 can be improved.

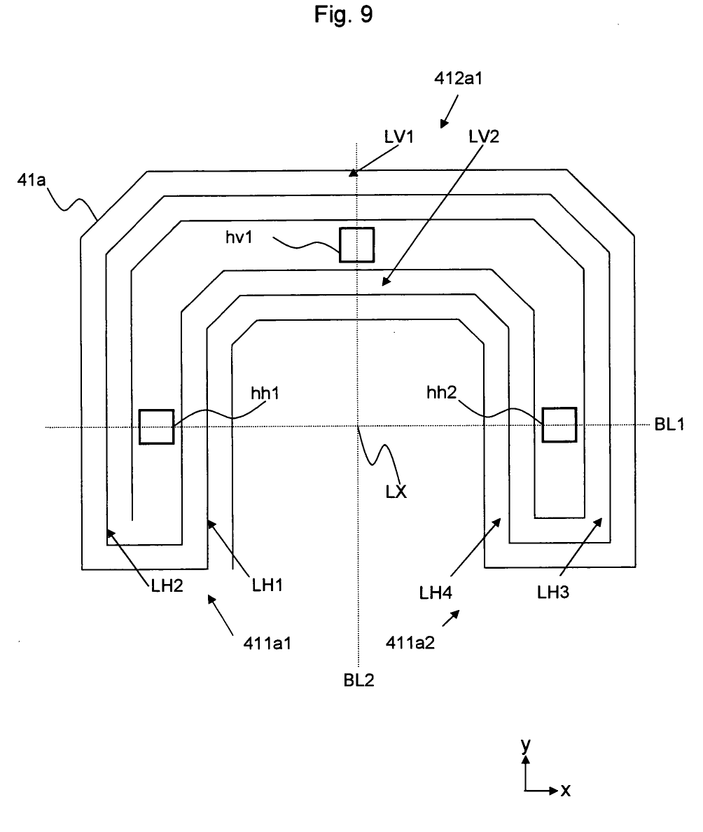

In the first embodiment, the outer circumference of the first position-detecting coil 41a forms a T character shape, viewed from the third direction z, however, the outer circumference of the first position-detecting coil 41a may form another shape (not the T character). In the second embodiment, the outer circumference of the first position-detecting coil 41a forms a U character shape, viewed from the third direction z, as another shape (see FIG. 9).

Therefore, the second embodiment is explained centering on the constructions of the photographing apparatus 1 in the second embodiment which are different from the constructions of the photographing apparatus 1 in the first embodiment.

The first position-detecting coil 41a is a coil which forms a seat and spiral shape coil pattern. The first position-detecting coil 41a is one coil which has a first horizontal position-detecting area 411a1 and a second horizontal position-detecting area 411a2 and a vertical position-detecting area 412a1. The first and second horizontal position-detecting areas 411a1 and 411a2 are used for detecting a position of the movable unit 30a in the first direction x. The vertical position-detecting area 412a1 is used for detecting a position of the movable unit 30a in the second direction y.

The first horizontal position-detecting area 411a1 has first horizontal position-detecting segments LH1 and second horizontal position-detecting segments LH2.

The first and second horizontal position-detecting segments LH1 and LH2 are parts of the first position-detecting coil 41a, and face the first horizontal hall element hh1 of the first hall element unit 44b. The first and second horizontal position-detecting segments LH1 and LH2 are parallel to the second direction y.

The direction of the current through the first horizontal position-detecting segments LH1 is opposite to the direction of the current through the second horizontal position-detecting segments LH2.

The second horizontal position-detecting area 411a2 has third horizontal position-detecting segments LH3 and fourth horizontal position-detecting segments LH4.

The third and fourth horizontal position-detecting segments LH3 and LH4 are parts of the first position-detecting coil 41a, and face the second horizontal hall element hh2 of the first hall element unit 44b. The third and fourth horizontal position-detecting segments LH3 and LH4 are parallel to the second direction y.

The direction of the current through the third horizontal position-detecting segments LH3 is opposite to the direction of the current through the fourth horizontal position-detecting segments LH4.

The vertical position-detecting area 412a1 has first vertical position-detecting segments LV1 and second vertical position-detecting segments LV2.

The first and second vertical position-detecting segments LV1 and LV2 are parts of the first position-detecting coil 41a, and face the vertical hall element hv1 of the first hall element unit 44b. The first and second vertical position-detecting segments LV1 and LV2 are parallel to the first direction x.

The direction of the current through the first vertical position-detecting segments LV1 is opposite to the direction of the current through the second vertical position-detecting segments LV2.

The first position-detecting coil 41a and the imaging unit 39a are attached to the movable circuit board 49a where a line which passes through the center area of the imaging device 39a1 and parallel to the third direction z, passes through an intersection area between a first perpendicular bisector BL1 and a second perpendicular bisector BL2 (see FIG. 9). The first perpendicular bisector BL1 is a perpendicular bisector of one of the segment of the first horizontal position-detecting segments LH1. The second perpendicular bisector BL2 is a perpendicular bisector of one of the segment of the first vertical position-detecting segments LV1.

Any segment of the first horizontal position-detecting segments LH1 can be used for defining the first perpendicular bisector BL1, because the segments constituting the first horizontal position-detecting segments LH1 are close to each other, so that a big difference will not occur. Similarly, any segment of the first vertical position-detecting segments LV1 can be used for defining the second perpendicular bisector BL2, because segments constituting the first vertical position-detecting segments LV1 are close to each other, so that a big difference does not occur.

The first horizontal position-detecting area 411al forms one of the two longitudinal line parts that form the U character. The second horizontal position-detecting area 411a2 forms another of the two longitudinal line parts that form the U character. The vertical position-detecting area 412a1 forms the bottom lateral line part that forms the U character.

The first perpendicular bisector BL1 may be a perpendicular bisector of one of the segment of the second, third, and fourth horizontal position-detecting segments LH2, LH3, and LH4. The second perpendicular bisector BL2 may be a perpendicular bisector of one of the segment of the second vertical position-detecting segments LV2.

The other constructions in the second embodiment are the same as those in the first embodiment.

In the first and second embodiments, the first hall element unit 44b has two hall elements for detecting the location in the first direction x, and one hall element for detecting the location in the second direction y. However, the first hall element unit 44b may have one hall element for detecting the location in the first direction x, and two hall elements for detecting the location in the second direction y.

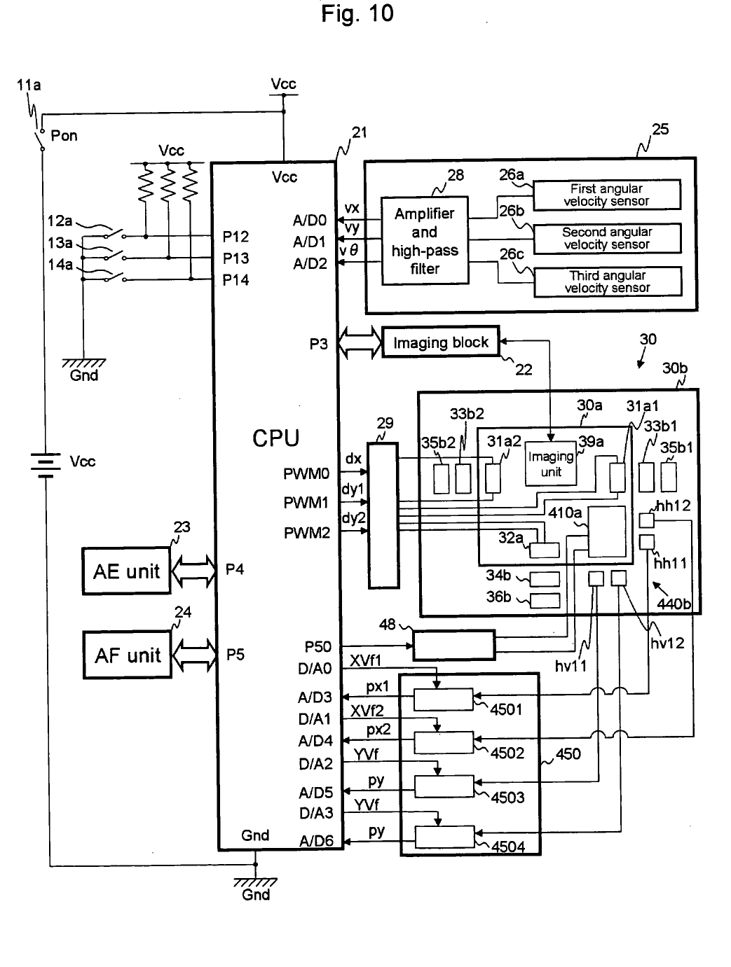

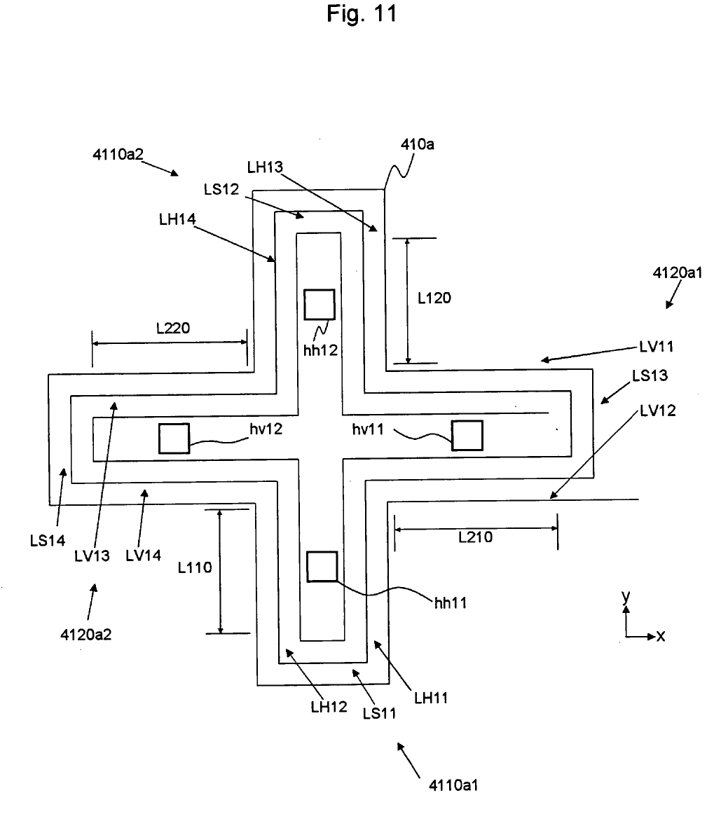

Next, the third embodiment is explained. In the third embodiment, constructions of the hall element unit and the hall-element signal-processing unit are different from those of the first embodiment (see FIGS. 10 and 11).

Therefore, the third embodiment is explained centering on the constructions of the photographing apparatus 1 in the third embodiment which are different from the constructions of the photographing apparatus 1 in the first embodiment.

In the third embodiment, the anti-shaking part of the photographing apparatus 1 comprises a second hall-element signal-processing unit 450 instead of the first hall-element signal-processing unit 45 in the first embodiment, so that the fixed unit 30b has a second hall element unit 440b instead of the first hall element unit 44b in the first embodiment.

The detected-position P of the movable unit 30a, either before moving and rotating or after moving and rotating, which is moved and rotated by driving the first driver circuit 29, is detected by the second hall element unit 440b and the second hall-element signal-processing unit 450.

Information in the first direction x for the detected-position P, in other words first and second horizontal detected-position signals px1 and px2 are input to the A/D converters A/D 3 and A/D 4 of the CPU 21. The first horizontal detected-position signal px1 is an analogue signal, and is converted to a digital signal through the A/D converter A/D 3 (A/D converting operation). The second horizontal detected-position signal px2 is an analogue signal, and is converted to a digital signal through the A/D converter A/D 4 (A/D converting operation).

Information in the second direction y for the detected-position P, in other words first and second vertical detected-position signals py1 and py2 are input to the A/D converters A/D 5 and A/D 6 of the CPU 21. The first vertical detected-position signal py1 is an analogue signal, and is converted to a digital signal through the A/D converter A/D 5 (A/D converting operation). The second vertical detected-position signal py2 is an analogue signal, and is converted to a digital signal through the A/D converter A/D 6 (A/D converting operation).

A first data in the first direction x for the detected-position P, after the A/D converting operation, is defined as pdx1, corresponding to the first horizontal detected-position signal px1.

A second data in the first direction x for the detected-position P, after the A/D converting operation, is defined as pdx2, corresponding to the second horizontal detected-position signal px2.

A data in the second direction y for the detected-position P, after the A/D converting operation, is defined as pdy1, corresponding to the first vertical detected-position signal py1.

A data in the second direction y for the detected-position P, after the A/D converting operation, is defined as pdy2, corresponding to the second vertical detected-position signal py2.

A first location in the first direction x for the detected-position P, after the calculating operation for the data pdx1, pdx2, pdy1, and pdy2, is defined as pxx.

A second location in the second direction y for the detected-position P, after the calculating operation for the data pdx1, pdx2, pdy1, and pdy2, is defined as pyy.

A rotation angle on the xy plane for the detected-position P, after the calculating operation for the data pdx1, pdx2, pdy1, and pdy2, is defined as pθ.

The PID (Proportional Integral Differential) control is performed on the basis of the data for the detected-position P (pxx, pyy, pθ) and the data for the position S (sx, sy, sθ) which should be moved to and be rotated to.

The second position-detecting coil 410a is a coil which forms a seat and spiral shape coil pattern. The second position-detecting coil 410a is one coil which has a first horizontal position-detecting area 4110a1 and a second horizontal position-detecting area 4110a2 and a first vertical position-detecting area 4120a1 and a second vertical position-detecting area 4120a2. The first and second horizontal position-detecting areas 4110a1 and 4110a2 are used for detecting a position of the movable unit 30a in the first direction x. The first and second vertical position-detecting areas 4120a1 and 4120a2 are used for detecting a position of the movable unit 30a in the second direction y.

The first horizontal position-detecting area 4110a1 has first horizontal position-detecting segments LH11, second horizontal position-detecting segments LH12, and first short-segments LS11.

The first and second horizontal position-detecting segments LH11 and LH12 and the first short-segments LS11 are parts of the second position-detecting coil 410a, and face the first horizontal hall element hh11 of the second hall element unit 440b which is described later. The first and second horizontal position-detecting segments LH11 and LH12 are parallel to the second direction y, before the movable unit 30a is rotated.

The direction of the current through the first horizontal position-detecting segments LH11 is opposite to the direction of the current through the second horizontal position-detecting segments LH12.

The first short-segments LS11 are parallel to the first direction x, and are connected with the first and second horizontal position-detecting segments LH11 and LH12.

The second horizontal position-detecting area 4110a2 has third horizontal position-detecting segments LH13, fourth horizontal position-detecting segments LH14, and second short-segments LS12.

The third and fourth horizontal position-detecting segments LH13 and LH14 and the second short-segments LS12 are parts of the second position-detecting coil 410a, and face the second horizontal hall element hh12 of the second hall element unit 440b which is described later. The third and fourth horizontal position-detecting segments LH13 and LH14 are parallel to the second direction y, before the movable unit 30a is rotated.

The direction of the current through the third horizontal position-detecting segments LH13 is opposite to the direction of the current through the fourth horizontal position-detecting segments LH14.

The second short-segments LS12 are parallel to the first direction x, and are connected with the third and fourth horizontal position-detecting segments LH13 and LH14.

The first vertical position-detecting area 4120al has first vertical position-detecting segments LV11, second vertical position-detecting segments LV12, and third short-segments LS13. The first and second vertical position-detecting segments LV11 and LV12 and the third short-segments LS13 are parts of the second position-detecting coil 410a, and face the first vertical hall element hv11 of the second hall element unit 440b which is described later. The first and second vertical position-detecting segments LV11 and LV12 are parallel to the first direction x, before the movable unit 30a is rotated.

The direction of the current through the first vertical position-detecting segments LV11 is opposite to the direction of the current through the second vertical position-detecting segments LV12.

The third short-segments LS13 are parallel to the second direction y, and are connected with the first and second vertical position-detecting segments LV11 and LV12.

The second vertical position-detecting area 4120a2 has third vertical position-detecting segments LV13, fourth vertical position-detecting segments LV14, and fourth short-segments LS14. The third and fourth vertical position-detecting segments LV13 and LV14 and the fourth short-segments LS14 are parts of the second position-detecting coil 410a, and face the second vertical hall element hv12 of the second hall element unit 440b which is described later. The third and fourth vertical position-detecting segments LV13 and LV14 are parallel to the first direction x, before the movable unit 30a is rotated.

The direction of the current through the third vertical position-detecting segments LV13 is opposite to the direction of the current through the fourth vertical position-detecting segments LV14.

The fourth short-segments LS14 are parallel to the second direction y, and are connected with the third and fourth vertical position-detecting segments LV13 and LV14.

The first, second, third and fourth horizontal position-detecting segments LH11, LH12, LH13, and LH14 and the first, second, third, and fourth vertical position-detecting segments LV11, LV12, LV13, and LV14 are composed of coil segments. The number of segments is the same as the number of times the second position-detecting coil 410a is wound round.

The number of times the second position-detecting coil 410a is wound round is in integers of 1 or more, so that the number of segments of the first, second, third and fourth horizontal position-detecting segments LH11, LH12, LH13, and LH14 and the first, second, third, and fourth vertical position-detecting segments LV11, LV12, LV13, and LV14 is equal to 1 or integers greater than 1.

In the third embodiment, the number of times the second position-detecting coil 410a is wound round is 3, so that the number of first, second, third and fourth horizontal position-detecting segments LH11, LH12, LH13, and LH14 and the number of first, second, third, and fourth vertical position-detecting segments LV11, LV12, LV13, and LV14 is 3 (see FIG. 11).

Magnetic-fields are generated radially around the first horizontal position-detecting segments LH11, on the basis of the current which flows through the first horizontal position-detecting segments LH11 (the second position-detecting coil 410a).

Magnetic-fields are generated radially around the second horizontal position-detecting segments LH12, on the basis of the current which flows through the second horizontal position-detecting segments LH12 (the second position-detecting coil 410a).

The direction of the magnetic-fields, which are generated around the first and second horizontal position-detecting segments LH11 and LH12, is almost parallel to the third direction z, near the first horizontal hall element hh11.

Magnetic-fields are generated radially around the third horizontal position-detecting segments LH13, on the basis of the current which flows through the third horizontal position-detecting segments LH13 (the second position-detecting coil 410a).

Magnetic-fields are generated radially around the fourth horizontal position-detecting segments LH14, on the basis of the current which flows through the fourth horizontal position-detecting segments LH14 (the second position-detecting coil 410a).

The direction of the magnetic-fields, which are generated around the third and fourth horizontal position-detecting segments LH13 and LH14, is almost parallel to the third direction z, near the second horizontal hall element hh12.

Magnetic-fields are generated radially around the first vertical position-detecting segments LV11, on the basis of the current which flows through the first vertical position-detecting segments LV11 (the second position-detecting coil 410a).

Magnetic-fields are generated radially around the second vertical position-detecting segments LV12, on the basis of the current which flows through the second vertical position-detecting segments LV12 (the second position-detecting coil 41a).

The direction of the magnetic-fields, which are generated around the first and second vertical position-detecting segments LV11 and LV12, is almost parallel to the third direction z, near the first vertical hall element hv11.

Magnetic-fields are generated radially around the third vertical position-detecting segments LV13, on the basis of the current which flows through the third vertical position-detecting segments LV13 (the second position-detecting coil 410a).

Magnetic-fields are generated radially around the fourth vertical position-detecting segments LV14, on the basis of the current which flows through the fourth vertical position-detecting segments LV14 (the second position-detecting coil 41a).

The direction of the magnetic-fields, which are generated around the third and fourth vertical position-detecting segments LV13 and LV14, is almost parallel to the third direction z, near the second vertical hall element hv12.

The first and second horizontal position-detecting segments LH11 and LH12 have a first horizontal effective position-detecting length L110, where the magnetic-field, which is formed from the magnetic-fields which are generated radially around the first and second horizontal position-detecting segments LH11 and LH12, and which influences the first horizontal hall element hh11, is not changed during movement of the movable unit 30a in the second direction y. The first horizontal effective position-detecting length L110 is longer than the movement range of the movable unit 30a in the second direction y.

The third and fourth horizontal position-detecting segments LH13 and LH14 have a second horizontal effective position-detecting length L120, where the magnetic-field, which is formed from the magnetic-fields which are generated radially around the third and fourth horizontal position-detecting segments LH13 and LH14, and which influences the second horizontal hall element hh12, is not changed during movement of the movable unit 30a in the second direction y. The second horizontal effective position-detecting length L120 is longer than the movement range of the movable unit 30a in the second direction y.

The first and second vertical position-detecting segments LV11 and LV12 have a first vertical effective position-detecting length L210, where the magnetic-field, which is formed from the magnetic-fields which are generated radially around the first and second vertical position-detecting segments LV11 and LV12, and which influences the first vertical hall element hv11, is not changed during movement of the movable unit 30a in the first direction x. The first vertical effective position-detecting length L210 is longer than the movement range of the movable unit 30a in the first direction x.

The third and fourth vertical position-detecting segments LV13 and LV14 have a second vertical effective position-detecting length L220, where the magnetic-field, which is formed from the magnetic-fields which are generated radially around the third and fourth vertical position-detecting segments LV13 and LV14, and which influences the second vertical hall element hv12, is not changed during movement of the movable unit 30a in the first direction x. The second vertical effective position-detecting length L220 is longer than the movement range of the movable unit 30a in the first direction x.

The lengths of the parts such as the first, second, third, and fourth short-segments LS11, LS12, LS13, and LS14, (the parts other than the first, second, third, and fourth horizontal position-detecting segments LH11, LH12, LH13, and LH14 and the first, second, third and fourth vertical position-detecting segments LV11, LV12, LV13, and LV14) of the second position-detecting coil 410a, are shorter than the first and second horizontal effective position-detecting lengths L110 and L120 and the first and second vertical effective position-detecting lengths L210 and L220.

Further, the lengths of the first short-segments LS11 are longer than the movement range of the first horizontal hall element hh11 (the movable unit 30a) in the first direction x.

Similarly, the lengths of the second short-segments LS12 are longer than the movement range of the second horizontal hall element hh12 (the movable unit 30a) in the first direction x.

Similarly, the lengths of the third short-segment LS13 are longer than the movement range of the first vertical hall element hv11 (the movable unit 30a) in the second direction y.

Similarly, the lengths of the fourth short-segment LS14 are longer than the movement range of the second vertical hall element hv12 (the movable unit 30a) in the second direction y.

Accordingly, the first short-segments LS11 generate magnetic-fields when current flows through the first short-segments LS11 (the second position-detecting coil 410a), however, the influence of the magnetic-field which is formed from the magnetic-fields which are generated radially around the first short-segments LS11, on the first horizontal hall element hh11, can be restrained, in comparison with the influence of the magnetic-field which is formed from the magnetic-fields which are generated radially around the first and second horizontal position-detecting segments LH11 and LH12, on the first horizontal hall element hh11.

Similarly, the second short-segments LS12 generate magnetic-fields when current flows through the second short-segments LS12 (the second position-detecting coil 410a), however, the influence of the magnetic-field which is formed from the magnetic-fields which are generated radially around the second short-segments LS12, on the second horizontal hall element hh12, can be restrained, in comparison with the influence of the magnetic-field which is formed from the magnetic-fields which are generated radially around the third and fourth horizontal position-detecting segments LH13 and LH14, on the second horizontal hall element hh12.

Similarly, the third short-segments LS13 generate magnetic-fields when current flows through the third short-segments LS13 (the second position-detecting coil 410a), however, the influence of the magnetic-field which is formed from the magnetic-fields which are generated radially around the third short-segments LS13, on the first vertical hall element hv11, can be restrained, in comparison with the influence of the magnetic-field which is formed from the magnetic-fields which are generated radially around the first and second vertical position-detecting segments LV11 and LV12, on the first vertical hall element hv11.

Similarly, the fourth short-segments LS14 generate magnetic-fields when current flows through the fourth short-segments LS14 (the second position-detecting coil 410a), however, the influence of the magnetic-field which is formed from the magnetic-fields which are generated radially around the fourth short-segments LS14, on the second vertical hall element hv12, can be restrained, in comparison with the influence of the magnetic-field which is formed from the magnetic-fields which are generated radially around the third and fourth vertical position-detecting segments LV13 and LV14, on the second vertical hall element hv12.

Therefore, the position-detecting accuracy, when using the first, second, third, and fourth horizontal position-detecting segments LH11, LH12, LH13, LH14 and the first and second horizontal hall elements hh11 and hh12 and when using the first, second, third, and fourth vertical position-detecting segments LV11 and LV12 and the first and second vertical hall elements hv11 and hv12, can be improved in comparison with when the lengths of the first, second, third, and fourth short-segments LS1, LS2, LS3, and LS4 are not shorter than the first and second horizontal effective position-detecting lengths L110 and L120 and the first and second vertical effective position-detecting lengths L210 and L220.

The outer circumference of the second position-detecting coil 410a forms a cross character shape, viewed from the third direction z.

The second position-detecting coil 410a is attached on the opposite side of the movable circuit board 49a to the imaging unit 39a.

Further, the first position-detecting coil 41a and the imaging unit 39a are attached where a line which is parallel to the third direction z and which passes through the center area of the imaging device 39a1, passes through an intersection area of two lines constituting this cross character of the second position-detecting coil 410a. This is because the position-detecting accuracy is improved, as the position of the data for the detected-position P (pxx, pyy, pθ) which are calculated on the basis of the first and second horizontal detected-position signals px1 and px2 and the first and second vertical detected-position signal py1 and py2, becomes close the center of the imaging device 39a1.

Accordingly, the movement quantity of the imaging device 39a1 in the movable unit 30a, becomes nearly equal to the movement quantity of the position-detecting member (or the second position-detecting coil 410a) in the movable unit 30a. The movement quantity includes the rotating angle.

The first horizontal position-detecting area 4110a1 forms the bottom part of the longitudinal line part that forms the cross character. The second horizontal position-detecting area 4110a2 forms the upper part of the longitudinal line part that forms the cross character. The first vertical position-detecting area 4120a1 forms the right side part of the lateral line part that forms the cross character. The second vertical position-detecting area 4120a2 forms the left side part of the lateral line part that forms the cross character.

Because the second position-detecting coil 410a has a seat and spiral shape coil pattern, the thickness of the second position-detecting coil 410a, in the third direction z, can be thinned down in the third direction z, in comparison with when the permanent magnet is used as the magnetic-field generating apparatus for detecting the position of the movable unit 30a.

Therefore, it is possible to reduce the size of the anti-shake apparatus 30, by reducing the distance between the movable unit 30a and the fixed unit 30b in the third direction z.

Further, the second position-detecting coil 410a may consist of a plurality of seat coils which are layered in the third direction z. Even if the second position-detecting coil 410a consists of some seat coils which are layered in the third direction z, the thickness of the second position-detecting coil 410a is not increased in the third direction z, however, the number of times the second position-detecting coil 410a is wound round can be increased, so that the magnetic-flux density between the second position-detecting coil 410a and the second hall element unit 440b can be raised, and position-detecting accuracy can be improved.

The second position-detecting coil 410a is connected with the second driver circuit 48, which drives the second position-detecting coil 410a, through the flexible circuit board (not depicted). The second driver circuit 48 determines the supply of electricity to the second position-detecting coil 410a, on the basis of the on state of the signal output from the port P50 of the CPU 21, and stops the supply of electricity to the second position-detecting coil 410a, on the basis of the off state of the signal output from the port P50 of the CPU 21.

The second hall element unit 440b is attached to the movable unit side of the fixed unit 30b, where the second hall element unit 440b faces the second position-detecting coil 410a in the third direction z.

The second hall element unit 440b is a one-axis hall element which has four hall elements that are magnetoelectric converting elements (magnetic-field change-detecting elements) using the Hall Effect. The second hall element unit 440b detects the first horizontal detected-position signal px1, and the second horizontal detected-position signal px2, and the first vertical detected-position signal py1, and the second vertical detected-position signal py2.

Two of the four hall elements are first and second horizontal hall elements hh11 and hh12 for detecting the first and second horizontal detected-position signals px1 and px2, and the others are first and second vertical hall elements hv11 and hv12 for detecting the first and second vertical detected-position signals py1 and py2 (see FIG. 11).

The first horizontal hall element hh11 is attached to the sensor circuit board 66b of the fixed unit 30b, under the condition where the first horizontal hall element hh11 faces the first horizontal position-detecting area 4110al of the second position-detecting coil 410a of the movable unit 30a, in the third direction z.

The second horizontal hall element hh12 is attached to the sensor circuit board 66b of the fixed unit 30b, under the condition where the second horizontal hall element hh12 faces the second horizontal position-detecting area 4110a2 of the second position-detecting coil 410a of the movable unit 30a, in the third direction z.

The first vertical hall element hv11 is attached to the sensor circuit board 66b of the fixed unit 30b, under the condition where the first vertical hall element hv11 faces the first vertical position-detecting area 4120a1 of the second position-detecting coil 410a of the movable unit 30a, in the third direction z.

The second vertical hall element hv12 is attached to the sensor circuit board 66b of the fixed unit 30b, under the condition where the second vertical hall element hv12 faces the second vertical position-detecting area 4120a2 of the second position-detecting coil 410a of the movable unit 30a, in the third direction z.

When the center of the imaging device 39a1, passes through the optical axis LX before the movable unit 30a is rotated, it is desirable that the first horizontal hall element hh11 is located at a place on the second hall element unit 440b which faces an intermediate area between the first and second horizontal position-detecting segments LH11 and LH12 of the second position-detecting coil 410a in the first direction x, to perform the position-detecting operation utilizing the full size of the first horizontal position-detecting area 4110a1.

Further, when the center of the imaging device 39a1, passes through the optical axis LX before the movable unit 30a is rotated, it is desirable that the first horizontal hall element hh11 is located at a place on the second hall element unit 440b which faces an intermediate area of the first horizontal position-detecting segments LH11 (or the second horizontal position-detecting segments LH12) in the second direction y, in other words, which faces an intermediate area of the segments which form the first horizontal effective position-detecting length L110.

Similarly, when the center of the imaging device 39a1, passes through the optical axis LX before the movable unit 30a is rotated, it is desirable that the second horizontal hall element hh12 is located at a place on the second hall element unit 440b which faces an intermediate area between the third and fourth horizontal position-detecting segments LH13 and LH14 of the second position-detecting coil 410a in the first direction x, to perform the position-detecting operation utilizing the full size of the second horizontal position-detecting area 4110a2.

Further, when the center of the imaging device 39a1, passes through the optical axis LX before the movable unit 30a is rotated, it is desirable that the second horizontal hall element hh12 is located at a place on the second hall element unit 440b which faces an intermediate area of the third horizontal position-detecting segments LH13 (or the fourth horizontal position-detecting segments LH14) in the second direction y, in other words, which faces an intermediate area of the segments which form the second horizontal effective position-detecting length L120.

Similarly, when the center of the imaging device 39a1, passes through the optical axis LX before the movable unit 30a is rotated, it is desirable that the first vertical hall element hv11 is located at a place on the second hall element unit 440b which faces an intermediate area between the first and second vertical position-detecting segments LV11 and LV12 of the second position-detecting coil 410a in the second direction y, to perform the position-detecting operation utilizing the full size of the first vertical position-detecting area 4120a1.

Further, when the center of the imaging device 39a1, passes through the optical axis LX before the movable unit 30a is rotated, it is desirable that the first vertical hall element hv11 is located at a place on the second hall element unit 440b which faces an intermediate area of the first vertical position-detecting segments LV11 (or the second vertical position-detecting segments LV12) in the first direction x, in other words, which faces an intermediate area of the segments which form the first vertical effective position-detecting length L210.

Similarly, when the center of the imaging device 39a1, passes through the optical axis LX before the movable unit 30a is rotated, it is desirable that the second vertical hall element hv12 is located at a place on the second hall element unit 440b which faces an intermediate area between the third and fourth vertical position-detecting segments LV13 and LV14 of the second position-detecting coil 410a in the second direction y, to perform the position-detecting operation utilizing the full size of the second vertical position-detecting area 4120a2.

Further, when the center of the imaging device 39a1, passes through the optical axis LX before the movable unit 30a is rotated, it is desirable that the second vertical hall element hv12 is located at a place on the second hall element unit 440b which faces an intermediate area of the third vertical position-detecting segments LV13 (or the fourth vertical position-detecting segments LV14) in the first direction x, in other words, which faces an intermediate area of the segments which form the second vertical effective position-detecting length L220.

The second hall-element signal-processing unit 450 has a fourth hall-element signal-processing circuit 4501 and a fifth hall-element signal-processing circuit 4502 and a sixth hall-element signal-processing circuit 4503 and a seventh hall-element signal-processing circuit 4504.

The fourth hall-element signal-processing circuit 4501 detects a first horizontal potential-difference between output terminals of the first horizontal hall element hh11, based on an output signal of the first horizontal hall element hh11.

The fourth hall-element signal-processing circuit 4501 outputs the first horizontal detected-position signal px1 to the A/D converter A/D 3 of the CPU 21, on the basis of the first horizontal potential-difference. The first horizontal detected-position signal px1 specifies a location of the part of the movable unit 30a which faces the first horizontal hall element hh11, in the first direction x.

The fifth hall-element signal-processing circuit 4502 detects a second horizontal potential-difference between output terminals of the second horizontal hall element hh12, based on an output signal of the second horizontal hall element hh12.

The fifth hall-element signal-processing circuit 4502 outputs the second horizontal detected-position signal px2 to the A/D converter A/D 4 of the CPU 21, on the basis of the second horizontal potential-difference. The second horizontal detected-position signal px2 specifies a location of the part of the movable unit 30a which faces the second horizontal hall element hh12, in the first direction x.

The sixth hall-element signal-processing circuit 4503 detects a first vertical potential-difference between output terminals of the first vertical hall element hv11, based on an output signal of the first vertical hall element hv11.

The sixth hall-element signal-processing circuit 4503 outputs the first vertical detected-position signal py1 to the A/D converter A/D 5 of the CPU 21, on the basis of the first vertical potential-difference. The first vertical detected-position signal py1 specifies a location of the part of the movable unit 30a which faces the first vertical hall element hv11, in the second direction y.

The seventh hall-element signal-processing circuit 4504 detects a second vertical potential-difference between output terminals of the second vertical hall element hv12, based on an output signal of the second vertical hall element hv12.

The seventh hall-element signal-processing circuit 4504 outputs the second vertical detected-position signal py2 to the A/D converter A/D 6 of the CPU 21, on the basis of the second vertical potential-difference. The second vertical detected-position signal py2 specifies a location of the part of the movable unit 30a which faces the second vertical hall element hv12, in the second direction y.

A first horizontal voltage XVf1 is applied to the input terminals of the first horizontal hall element hh11 through the fourth hall-element signal-processing circuit 4501, from the D/A converter D/A 0 of the CPU 21, during the position-detecting operation.

A second horizontal voltage XVf2 is applied to the input terminals of the second horizontal hall element hh12 through the fifth hall-element signal-processing circuit 4502, from the D/A converter D/A 1 of the CPU 21, during the position-detecting operation.

A first vertical voltage YVf1 is applied to the input terminals of the first vertical hall element hv11 through the sixth hall-element signal-processing circuit 4503, from the D/A converter D/A 2 of the CPU 21, during the position-detecting operation.

A second vertical voltage YVf2 is applied to the input terminals of the second vertical hall element hv12 through the seventh hall-element signal-processing circuit 4504, from the D/A converter D/A 3 of the CPU 21, during the position-detecting operation.

The other constructions in the third embodiment are the same as those in the first embodiment.

In the third embodiment, the four hall elements (hh11, hh12, hv11, and hv12) are used for specifying the location of the movable unit 30a which includes the rotating angle.

By using two of the four hall elements (hh11 and hh12), the locations in the first direction x of the two points on the movable unit 30a are specified. By using the other two hall elements (hv11 and fv12), the locations in the second direction y of the two points on the movable unit 30a are specified. The location of the movable unit 30a which includes the rotating angle on the xy plane, can be specified on the basis of this information regarding the locations in the first direction x of the two points and the locations in the second direction y of the two points.

In the third embodiment, the calculation for detecting the location of the movable unit 30a which includes the rotating angle, can be simplified in comparison with that of the first embodiment.

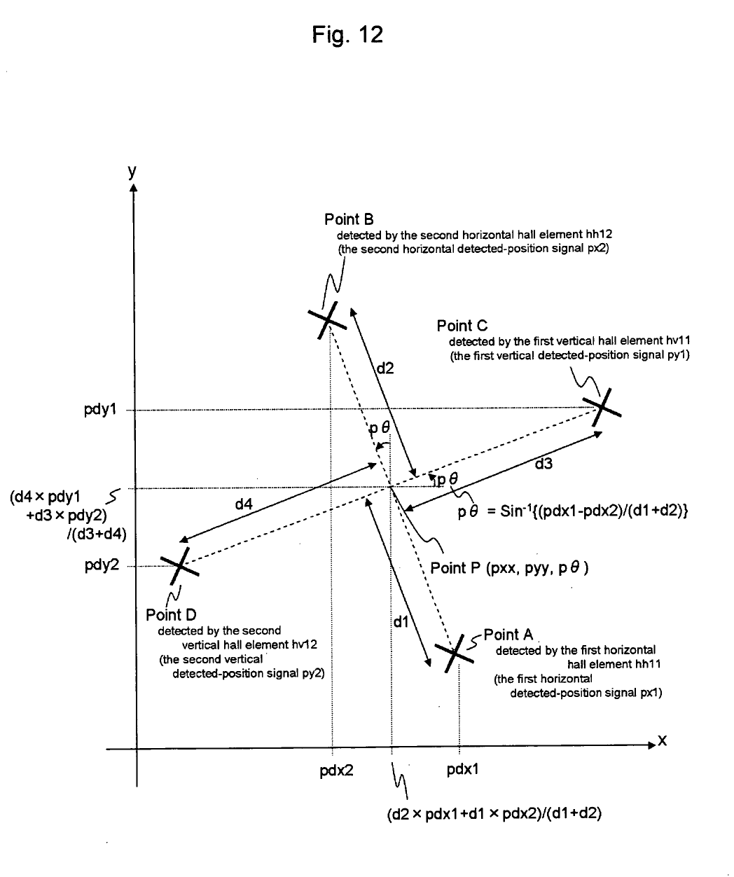

An example is explained using FIG. 12. The location of the point P (pxx, pyy, pθ) is calculated on the basis of a location-information of a point A, a point B, a point C, and a point D on the movable unit 30a. The point P is defined as an intersection point between a segment AB and a segment CD. The positions of the point A, the point B, the point C, and the point D are specified by the shape of the second position-detecting coil 410a. Accordingly, in the case where the second position-detecting coil 410a and the imaging unit 39a are attached to the movable circuit board 49a, and where the point P agrees with the center of the imaging device 39a1 in the third direction z, the location including rotating angle of the center of the imaging device 39a1 can be calculated by detecting the position P.

The location in the first direction x of the point A is detected by the first horizontal hall element hh11, as the first horizontal detected-position signal px1. The location in the first direction of the point B is detected by the second horizontal hall element hh12, as the second horizontal detected-position signal px2. The location in the second direction y of the point C is detected by the first vertical hall element hv11, as the first vertical detected-position signal py1. The location in the second direction y of the point D is detected by the second vertical hall element hv12, as the second vertical detected-position signal py2.

The data for the position P (pxx, pyy, pθ) are calculated on the basis of the data pdx1 which is converted from the first horizontal detected-position signal px1 in the A/D converting operation, the data pdx2 which is converted from the second horizontal detected-position signal px2 in the A/D converting operation, the data pdy1 which is converted from the first vertical detected-position signal py1 in the A/D converting operation, the data pdy2 which is converted from the second vertical detected-position signal py2 in the A/D converting operation, a segment AP having length d1, a segment BP having length d2, a segment CP having length d3, and a segment DP having length d4, where pxx=(d2×pdx1+d1×pdx2)÷(d1+d2), pyy=(d4×pdy1+d3×pdy2)÷(d3+d4), and pθ=Sin⁻¹{(pdx1−pdx2)÷(d1+d2)}=Sin⁻¹{(pdy1−pdy2)÷(d3+d4)}. The rotating angle pθ is an angle between the segment CD and the first direction x or between the segment AB and the second direction y.

Further, the number of the hall elements is not limited three in the first and second embodiments or four in the third embodiment. If two or more hall elements are used as one of the horizontal hall element and the vertical hall element, and one or more hall elements are used as another of the horizontal hall element and the vertical hall element, for detecting the location of the movable unit 30a, the same effect can be obtained.

Further, it is explained that the hall element is used for position-detecting as the magnetic-field change-detecting element, however, another detecting element may be used for position-detecting. Specifically, the detecting element may be an MI (Magnetic Impedance) sensor, in other words a high-frequency carrier-type magnetic-field sensor, or a magnetic resonance-type magnetic-field detecting element, or an MR (Magneto-Resistance effect) element. When one of the MI sensor, the magnetic resonance-type magnetic-field detecting element, and the MR element is used, the information regarding the position of the movable unit can be obtained by detecting the magnetic-field change, similar to using the hall element.

Although these embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-135170 (filed on Apr. 30, 2004), which is expressly incorporated herein by reference, in its entirety.

1. An anti-shake apparatus of a photographing apparatus, comprising:
a movable unit that has an imaging device and a position-detecting coil having a horizontal position-detecting area which has first and second horizontal position-detecting segments and having a vertical position-detecting area which has first and second vertical position-detecting segments, and that can be moved and rotated on a plane which is perpendicular to an optical axis of a camera lens of said photographing apparatus; and
a fixed unit that has a magnetic-field change-detecting unit having a horizontal magnetic-field change-detecting element which is used for detecting a position of said movable unit in a first direction and having a vertical magnetic-field change-detecting element which is used for detecting a position of said movable unit in a second direction, and that supports said movable unit in a movable and rotatable situation on said plane, said first direction being perpendicular to said optical axis, and said second direction being perpendicular to said optical axis and said first direction;
said first and second horizontal position-detecting segments being parallel to said second direction and facing said horizontal magnetic-field change-detecting element;
a direction of the current through said first horizontal position-detecting segment being opposite to a direction of the current through said second horizontal position-detecting segment;
said first and second vertical position-detecting segments being parallel to said first direction and facing said vertical magnetic-field change-detecting element;
a direction of the current through said first vertical position-detecting segment being opposite to a direction of the current through said second vertical position-detecting segment; and
said magnetic-field change-detecting unit having one or more elements as one of said horizontal magnetic-field change-detecting element and said vertical magnetic-field change-detecting element, and having two or more elements as another of said horizontal magnetic-field change-detecting element and said vertical magnetic-field change-detecting element.

2. The anti-shake apparatus according to claim 1, wherein said magnetic-field change-detecting unit has one element as one of said horizontal magnetic-field change-detecting element and said vertical magnetic-field change-detecting element, and has two elements as another of said horizontal magnetic-field change-detecting element and said vertical magnetic-field change-detecting element.

3. The anti-shake apparatus according to claim 2, wherein said position-detecting coil is one coil; and
an outer circumference of said position-detecting coil forms a T character shape, viewed from a third direction which is parallel to said optical axis.

4. The anti-shake apparatus according to claim 3, wherein a line which is parallel to said third direction and passes through a center area of said imaging device, passes through an intersection area of two lines constituting said T character of said position-detecting coil.

5. The anti-shake apparatus according to claim 3, wherein said position-detecting coil has first and second horizontal position-detecting areas as said horizontal position-detecting area, and one vertical position-detecting area as said vertical position-detecting area;
said first horizontal position-detecting area forms one side part of the upper lateral line part that forms said T character;
said second horizontal position-detecting area forms another side part of the upper lateral line part that forms said T character;
said vertical position-detecting area forms the longitudinal line part that forms said T character;
said magnetic-field change-detecting unit has first and second horizontal magnetic-field change-detecting elements as said horizontal magnetic-field change-detecting element, and one vertical magnetic-field change-detecting element as said vertical magnetic-field change-detecting element;
said first horizontal magnetic-field change-detecting element faces said first horizontal position-detecting area;
said second horizontal magnetic-field change-detecting element faces said second horizontal position-detecting area; and
said vertical magnetic-field change-detecting element faces said vertical position-detecting area.

6. The anti-shake apparatus according to claim 2, wherein said position-detecting coil is one coil; and
an outer circumference of said position-detecting coil forms a U character shape, viewed from a third direction which is parallel to said optical axis.

7. The anti-shake apparatus according to claim 6, wherein a line which passes through a center area of said imaging device and is parallel to said third direction, passes through an intersection area between a first perpendicular bisector and a second perpendicular bisector;
said first perpendicular bisector is a perpendicular bisector of one of said first and second horizontal position-detecting segments; and
said second perpendicular bisector is a perpendicular bisector of one of said first and second vertical position-detecting segments.

8. The anti-shake apparatus according to claim 6, wherein said position-detecting coil has first and second horizontal position-detecting areas as said horizontal position-detecting area, and one vertical position-detecting area as said vertical position-detecting area;
said first horizontal position-detecting area forms one of the two longitudinal line parts that form said U character;
said second horizontal position-detecting area forms another of the two longitudinal line parts that form said U character;
said vertical position-detecting area forms the bottom lateral line part that forms said U character;
said magnetic-field change-detecting unit has first and second horizontal magnetic-field change-detecting elements as said horizontal magnetic-field change-detecting element, and one vertical magnetic-field change-detecting element as said vertical magnetic-field change-detecting element;
said first horizontal magnetic-field change-detecting element faces said first horizontal position-detecting area;
said second horizontal magnetic-field change-detecting element faces said second horizontal position-detecting area; and
said vertical magnetic-field change-detecting element faces said vertical position-detecting area.

9. The anti-shake apparatus according to claim 1, wherein said magnetic-field change-detecting unit has two elements as said horizontal magnetic-field change-detecting element and has two elements as said vertical magnetic-field change-detecting element.

10. The anti-shake apparatus according to claim 9, wherein said position-detecting coil is one coil; and
an outer circumference of said position-detecting coil forms a cross character shape, viewed from a third direction which is parallel to said optical axis.

11. The anti-shake apparatus according to claim 10, wherein a line which is parallel to said third direction and passes through a center area of said imaging device, passes through an intersection area of two lines constituting said cross character of said position-detecting coil.

12. The anti-shake apparatus according to claim 1, wherein said position-detecting coil forms a seat and a spiral shape coil pattern.

13. The anti-shake apparatus according to claim 12, wherein said position-detecting coil consists of a plurality of seat coils which are layered in a third direction which is parallel to said optical axis.

14. The anti-shake apparatus according to claim 1, wherein when a center of said imaging device passes through said optical axis, said horizontal magnetic-field change-detecting element is located at a place on said magnetic-field change-detecting unit which faces an intermediate area between said first and second horizontal position-detecting segments in said first direction, and said vertical magnetic-field change-detecting element is located at a place on said magnetic-field change-detecting unit which faces an intermediate area between said first and second vertical position-detecting segments in said second direction.

15. The anti-shake apparatus according to claim 1, wherein said horizontal magnetic-field change-detecting element and said vertical magnetic-field change-detecting element are hall elements.
